(19) United States
(12) Patent Application Publication
(10) Pub. No.: US 2018/0042704 A1
(43) Pub. Date: Feb. 15, 2018

(54) FULCRUM IMPLANT SYSTEMS

(71) Applicant: Kianor Shahmohammadi, Dana Point, CA (US)

(72) Inventor: Kianor Shahmohammadi, Dana Point, CA (US)

(21) Appl. No.: 15/236,806

(22) Filed: Aug. 15, 2016

(51) Int. Cl. A61C 8/00; A61C 5/30

(52) U.S. Cl. CPC A61C 8/0093; A61C 8/0012; A61C 8/0037; A61C 8/0019; A61C 5/30

(57) ABSTRACT

A dental implant device configured as a single, solid, unitary structure, including a body portion, multiplicity of wedging edge portion, and an apical end portion, wherein the implant device is configured to be installed in a patient's mandibular or maxillary bone. The apical end portion is configured to be beveled on a multiplicity of sides. The apical end portion may also include a joining surface, the joining surface has a saw-like serration pattern, a generally jagged pattern, or a smooth pointed edge to aid in locking the implant device to the maxilla or mandible to achieve initial stability and mechanical retention. The apical end portion may further include a multiplicity of generally circular holes to generally aid bone growth and facilitate stronger osseointegration. The dental implant comprises a biocompatible material including zirconia or titanium alloy. A minimum of 5 mm of the apical end portion would be inserted into the bone.

### FEDERALLY SPONSORED RESEARCH OR DEVELOPMENT

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to implant devices. More particularly, certain embodiments of the invention relate to dental implants.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

FIG. 1 illustrates an exemplary conventional top view cross section of a conventional dental implant 105 and a multiplicity of views of a conventional anterior crown 110 and a posterior crown 115, wherein the crowns may be fitted to an abutment or a prepared tooth. Typically, conventional dental implants may consist of a screw like exterior threading 120 and also may consist of an outer cross sectional design with a polygonal interior portion to create a locking mechanism to the abutment, like for example, implant 105 and further, may typically be placed in a straight line position when installed. Conventional dental implants may also involve drilling to create a circular space for delivery of an orally fixed prosthetic. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that conventional dental implants typically include multiple separate pieces such as, an apical insert, which may fit into a mandibular or maxillary bone processes, an abutment portion, which may be fixed to the apical insert, and screws for connecting the apical insert to the abutment portion or for joining the apical insert to the jaw or sealing the apical insert during healing, such as healing caps. Conventional crowns, like for example, crowns 110 and 115, may have a circular slot and may be placed on top of a circular or cylindrical abutment. Furthermore, it is contemplated that placement of conventional dental implants may be highly invasive and placed in drilled spaces generally comprising, at least, approximately, 1.5 mm of circumferential bone and can be cause of iatrogenic permanent damage to nerves and complications involved with other anatomical structures, such as maxillary sinuses.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary top view cross section of a conventional dental implant and a multiplicity of views of a conventional anterior crown and a conventional posterior crown;

FIG. 2A illustrates a front view of an exemplary embodiment of an implant device, in accordance with an embodiment of the present invention;

FIG. 2B illustrates a side view of an exemplary embodiment of an implant device, in accordance with an embodiment of the present invention;

FIG. 2C illustrates a top view cross section of an exemplary embodiment of an implant device, in accordance with an embodiment of the present invention;

FIG. 2D illustrates some exemplary embodiments of an implant device, in accordance with an embodiment of the present invention;

FIG. 3A and FIG. 3B illustrate various exemplary configurations of an exemplary embodiment of an implant device, in accordance with an embodiment of the present invention, where FIG. 3A illustrates some exemplary configurations of the implant device and FIG. 3B illustrates other exemplary configurations thereof;

FIG. 4 illustrates a side view of an exemplary alternative embodiment of an implant device, in accordance with an embodiment of the present invention;

FIG. 5 illustrates exemplary shape approximations of a posterior tooth and posterior root, in accordance with an embodiment of the present invention;

FIG. 6 illustrates an exemplary depth implementation of an exemplary embodiment of an implant device, in accordance with an embodiment of the present invention;

FIG. 7 illustrates exemplary top view implementations of exemplary embodiments of an implant device, in accordance with an embodiment of the present invention;

FIG. 8 illustrates an exemplary angular depth implementation of an exemplary embodiment of an implant device, in accordance with an embodiment of the present invention;

FIG. 9A and FIG. 9B illustrates various view of an exemplary installment implementation of an exemplary embodiment of an implant device, in accordance with an embodiment of the present invention, where FIG. 9A illustrates a top view of the exemplary installment implementation and FIG. 9B illustrates a front view thereof;

FIG. 10 illustrates an exemplary installment implementation of an exemplary embodiment of an implant device, in accordance with an embodiment of the present invention;

FIG. 11 illustrates an exemplary alternative embodiment of an implant device, in accordance with an embodiment of the present invention;

FIG. 12 illustrates an exemplary embodiment of an implant device system, in accordance with an embodiment of the present invention;

FIG. 13 illustrate an exemplary embodiment configuration of an implant device, in accordance with an embodiment of the present invention;

FIG. 14 illustrate an exemplary embodiment configuration of an implant device, in accordance with an embodiment of the present invention;

FIG. 15 illustrate an exemplary embodiment configuration of an implant device, in accordance with an embodiment of the present invention;

FIG. 16 illustrate an exemplary embodiment configuration of an implant device, in accordance with an embodiment of the present invention;

FIG. 17 illustrate an exemplary embodiment configuration of an implant device, in accordance with an embodiment of the present invention;

FIG. 18 illustrate an exemplary embodiment configuration of an implant device, in accordance with an embodiment of the present invention;

FIG. 19 illustrate an exemplary embodiment configuration of an implant device, in accordance with an embodiment of the present invention;

FIG. 20 illustrates exemplary surfaces and clearances of an exemplary tooth and crown fitted to an exemplary implant device, in accordance with an embodiment of the present invention;

FIG. 21 illustrates exemplary dental prosthetics, in accordance with an embodiment of the present invention.

FIG. 22 illustrates a flowchart of an exemplary method of fitting a crown to a patient, in accordance with an embodiment of the present invention;

FIG. 23 illustrates a flowchart of an exemplary method of installing an exemplary implant device using an exemplary implant device system, in accordance with an embodiment of the present invention;

FIG. 24A and FIG. 24B illustrate a flowchart of an exemplary method of fitting an orthodontic device or a long span implant bridge to a patient, in accordance with a present embodiment of the present invention, where FIG. 24A illustrates a start of the method, and FIG. 24B illustrates an end thereof.

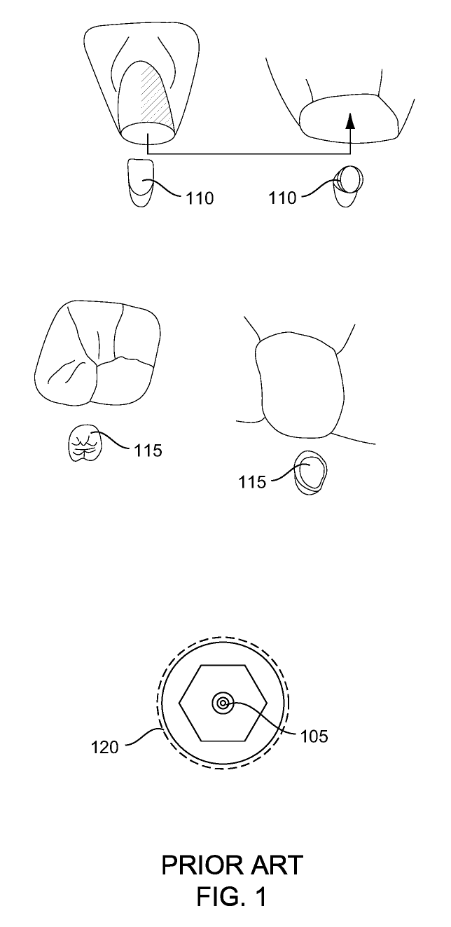

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. V. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See in re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially” ] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and contradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, in re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

As will be described in some detail below, in an embodiment of the present invention, an exemplary prepable implant device may be, without limitation, fixedly joined, at a multiplicity of exemplary angles, to a patient's jawbone without screws or attachable abutments. In many embodiments, the implant device may not be prepped. It is contemplated that a proper occlusal and circumferential clearance may exist in a case that a proper size for an implant location is possibly chosen. However, in a case that there is not adequate occlusal or circumferential clearance for a crown, or other dental prosthetic, after ideal placement in bone, then in many embodiment, the implant device may allow for minor adjustments to possibly be made intraorally. In some embodiments, an impression (digital or manual) maybe taken immediately after the implant device may be installed or when a healing process may be completed depending on at least local factors such as, and without limitation, initial stability, soft tissue and bone level, soft tissue and bone thickness, location of a site in the mouth, and bite relationship. Many embodiments of the present invention may allow a practitioner to perform a less invasive, immediate installation of at least one, single-unit structured, implant device, wherein the implant device may further be joined to an oral or prosthodontic device, wherein the device may be for example, and without limitation, a crown, a bridge, a full denture, a partial denture, an orthodontic device, space retainer, a bar, an attachment, a metal or plastic housing, a sinus lift device, a bone expansion device, a bone augmentation anchorage or column, a nerve displacement device, a prosthetic retention device, a cementation mechanism, a prosthetic substructure, an oral anchorage, veneers, porcelain jacket crowns, bar inserts that may engage the implant device to support dentures with 2 or more implant device substructures, implant device matching orthodontic bands, brackets, and wires that may anchor to the implant device, may move the implant device and/or may, aid with space maintenance (space maintainers), or substantially any other oral prosthesis.

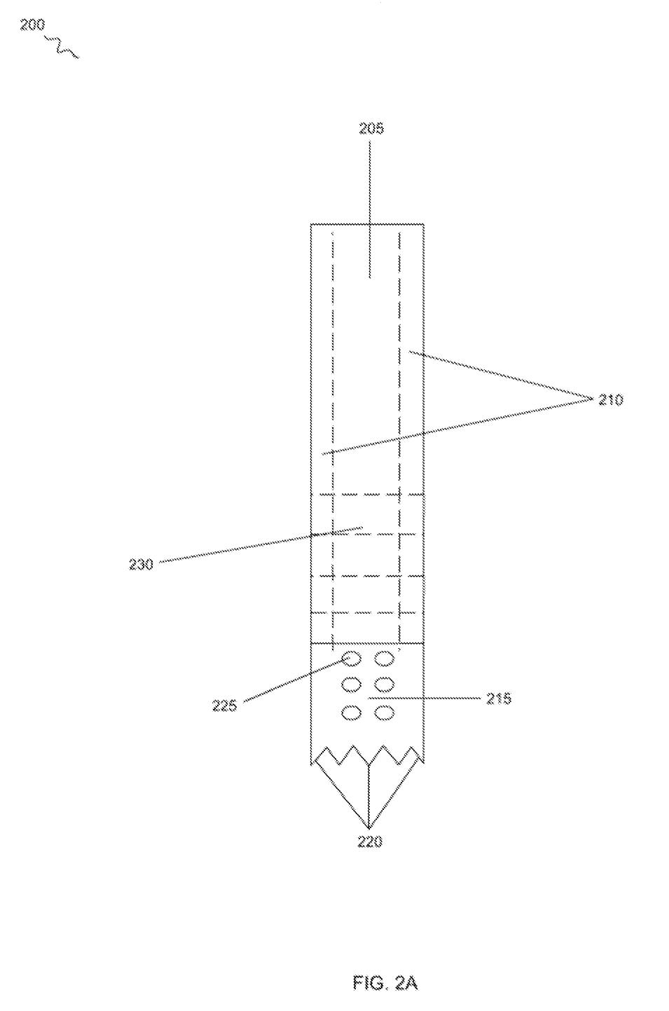

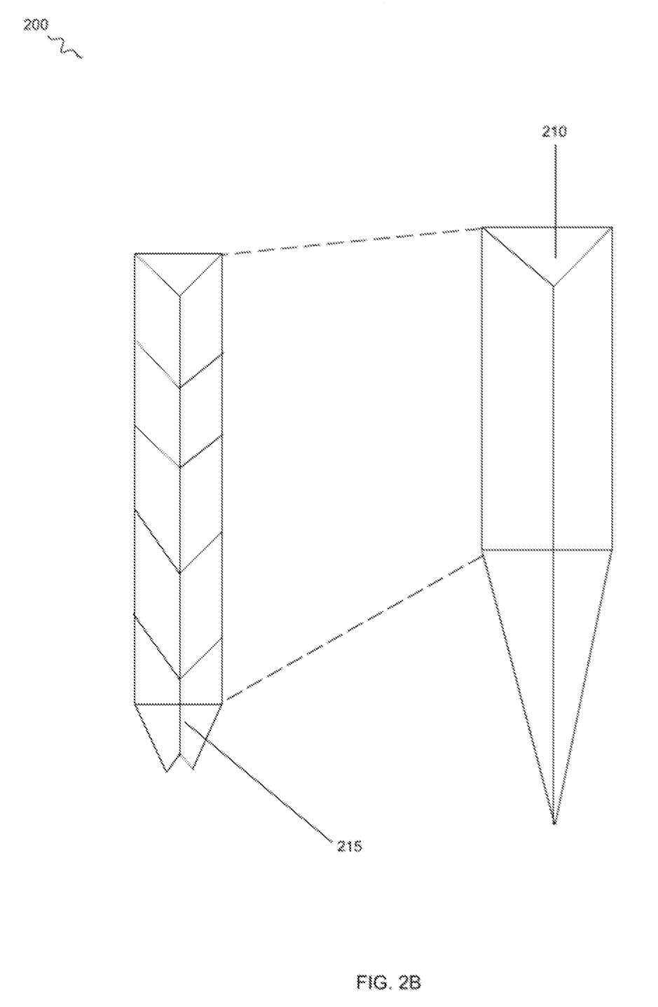

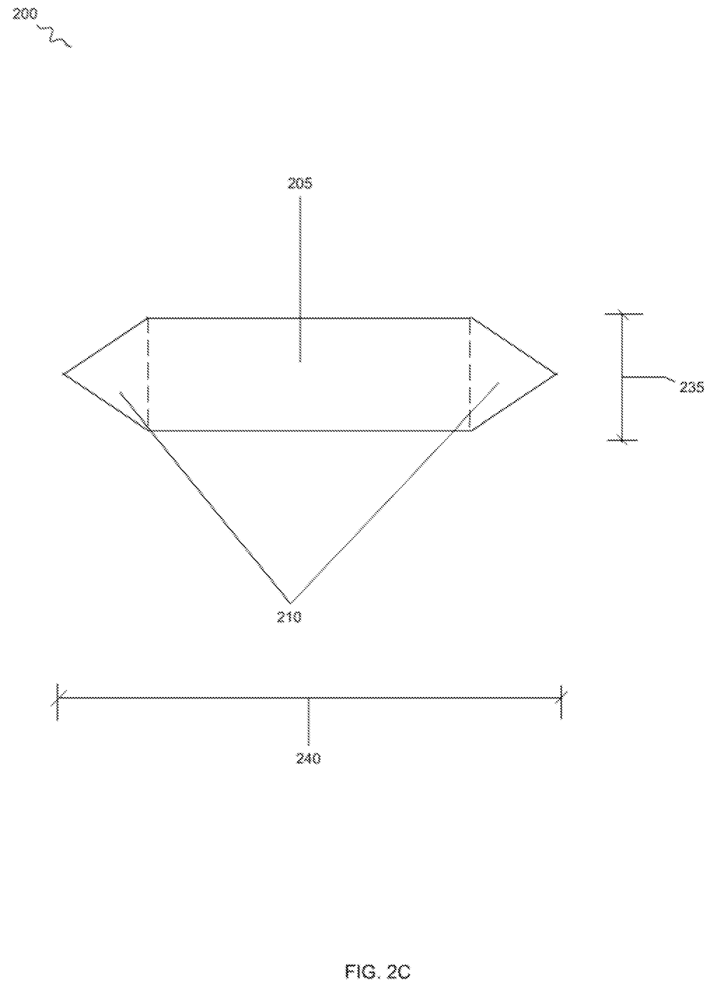

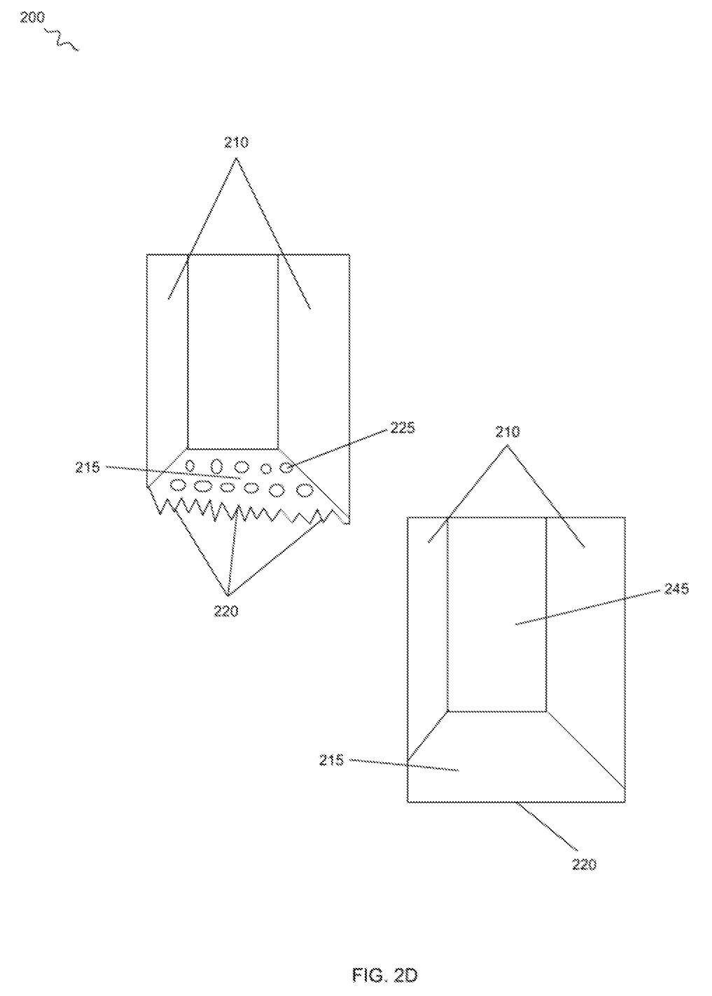

FIG. 2A illustrates a front view of an exemplary embodiment of an implant device 200, in accordance with an embodiment of the present invention. In the present invention, implant device 200 may be configured as a single, substantially solid, unitary structure, which may include a body portion 205, a multiplicity of wedging edge portion 210, and an apical end portion 215, wherein the implant device may be installed in a patient's bone, such as, and without limitation, a mandible and/or maxilla, apical end first. In the present embodiment, the apical end portion may be configured to be beveled on a multiplicity of sides and thus generally forms a chisel like shape. The apical end portion may also include a joining surface 220, wherein the joining surface may be a saw-like serration pattern, a generally jagged pattern, a smooth pointed edge, or any combination thereof, to generally aid in locking the implant device to the bone in order to achieve an initial stability and mechanical retention. Furthermore, the apical end portion may further include a multiplicity of generally circular holes 225, elevations, or other surface modifications to generally aid bone growth and facilitate stronger osseointegration. In the present embodiment, dental implant 200 may be configured as a single, substantially solid, unitary structure and may be comprised of an exemplary biocompatible material, such as, without limitation, zirconia or titanium alloy. Furthermore, the implant device may be of an optimal vertical height in an exemplary, without limitation, range of 6 mm to 50 mm in total vertical height, wherein the implant device may be optimally inserted into bone a distance of at least 5 mm. An optimal insertion distance may depend on many factors, at least including, and without limitation, height, thickness, anatomical structures, and type of bone. Furthermore, implant device 200 may include visual height markings 230 to generally aid a practitioner during installation by allowing the practitioner to see a depth at which the implant device may be inserted. Now, with reference to FIG. 2B, a side view of an exemplary embodiment of an implant device 200 is illustrated, in accordance with an embodiment of the present invention. In the present embodiment, wedging edge portion 210, may be configured to be substantially solid and may further include an exemplary, without limitation, wedge shape, wherein the wedge shape may be a tapered beveled shape which allows the implant to wedge into surrounding bone. The apical end portion may be a solid bevel or a modified bevel that may gradually increase in a multiplicity of dimensions coronally, wherein the apical end portion may expand a ridge when inserted and installed by a practitioner into position. In some embodiments the ridge may be narrower than the implant device. FIG. 2C illustrates a top view exemplary cross section of the exemplary embodiment of implant device 200, in accordance with an embodiment of the present invention. In the present embodiment, body portion 205, may be configured to include an exemplary, without limitation, cornered shape, wherein the cornered shape may comprise at least one corner. It is contemplated that one corner may prevent rotational movement of the implant device. Moreover, it may be further contemplated that multiple corners may allow the implant device to create a rotational/circumferential lock. Furthermore, the body portion may be solid, not hollow, and configured to be of a thickness 235, in an optimal exemplary, without limitation, range of 2 mm to 20 mm, wherein an apical end portion, may include holes. In many embodiments a minimum of 2 mm thickness may be optimal. In some other embodiments the thickness may range from 2 mm-20 mm. In the present embodiment, the implant device may be configured to include the wedging edge portion 210 on at least two sides of the body portion. Furthermore, implant device 200 may be configured to be a width 240, wherein the width may be in an optimal, exemplary, without limitation, range of 2 mm to 20 mm. FIG. 2D further illustrates some exemplary embodiments of the implant device described above, in accordance with an embodiment of the present invention. Furthermore, FIG. 2D more clearly shows the multiplicity of wedging edge portion 210, apical end portion 215, joining surface 220, and holes 225 as described above, wherein implant device 245, may comprise zirconia. Furthermore, in another embodiment an implant device may include a gradual taper from a coronal portion of the implant device to the apical end portion, such that, the implant device is may be thicker and/or wider at the coronal portion than at the apical end portion to generally aid in ridge expansion, wherein, an optimal thickness and width of the apical end portion may be a at least 1 mm in thickness (bevel) and 2 mm in width. Furthermore, the coronal portion may optimally be in a range of 2 mm-20 mm in thickness and may be in a range of 2 mm-20 mm in width, wherein the coronal portion may be a top portion of the implant device. In an alternative embodiment of the present invention, an implant device may be configured to include an exemplary tapered beveled wedging edge portion on at least one side of an implant device body portion. In another embodiment, holes may not be included in an implant device that comprises zirconia. In another embodiment, an implant device comprising zirconia may include an apical end portion that may be configured to be a solid bevel or a modified bevel, and may gradually increase in a multiplicity of dimensions coronally, wherein the apical end may further include a joining surface comprising a smooth pointed edge, without serrations. In many embodiments, a thickness may be in a range of 1-50 mm. In many embodiments a width may be in a range of 2-50 mm. In many embodiments a height may be in a range of 6-50 mm.

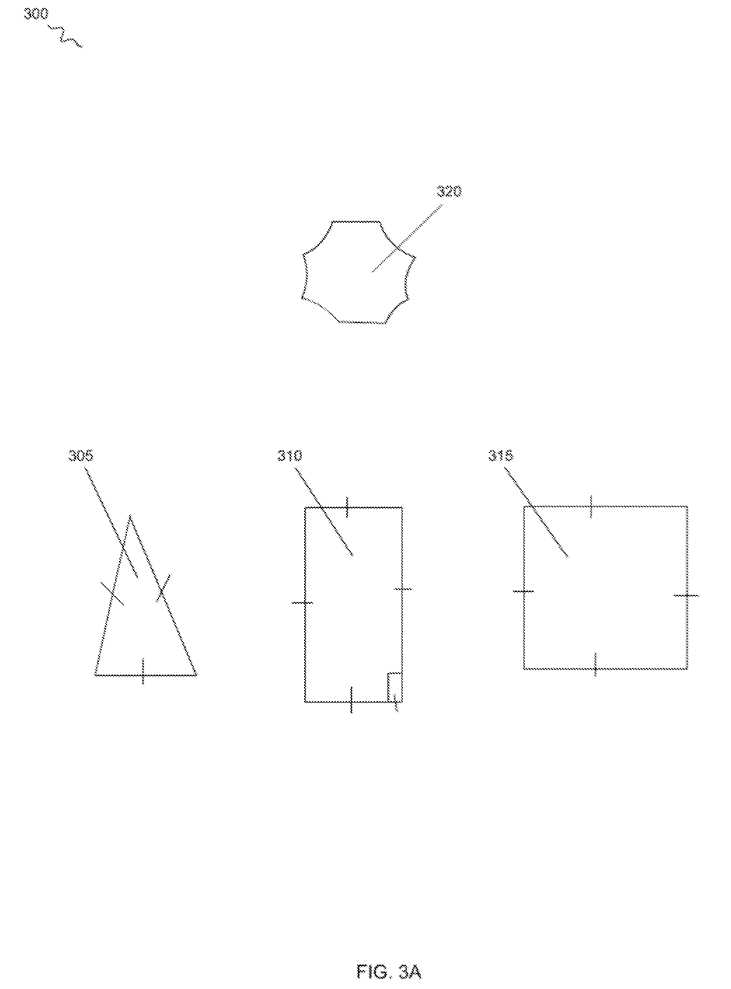

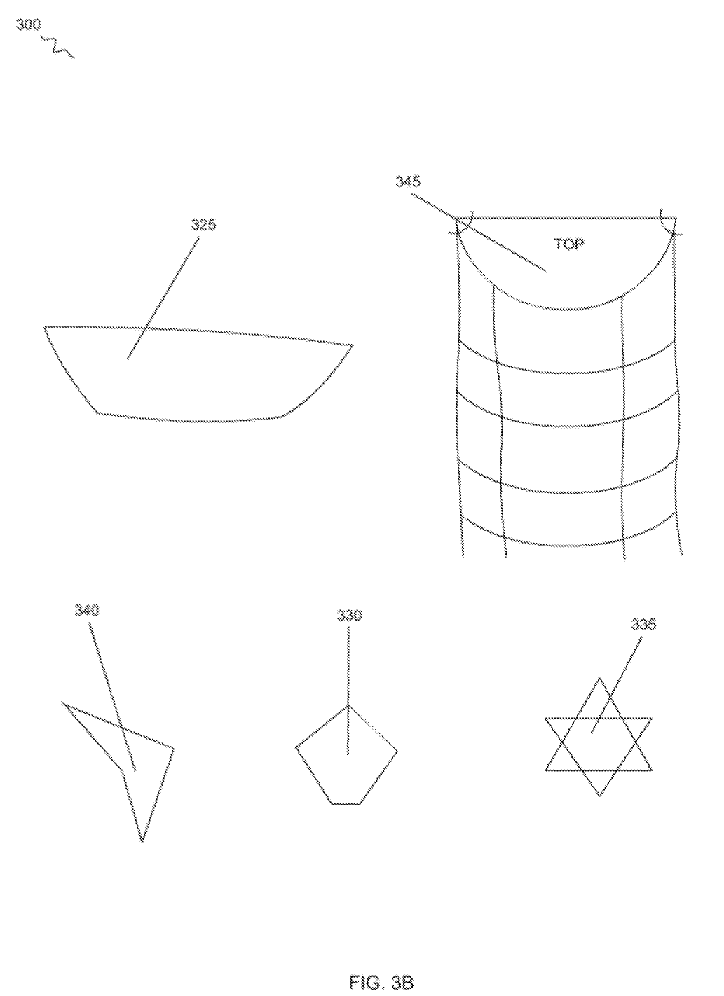

FIG. 3A and FIG. 3B illustrate various exemplary, without limitation, configurations of an exemplary embodiment of an implant device body portion 300, in accordance with an embodiment of the present invention, where FIG. 3A illustrates some exemplary, without limitation, configurations of the implant device in cross-section, and FIG. 3B illustrates other exemplary, without limitation, configurations thereof. In another embodiment, a cornered shape may be substantially any regular polygon shape, wherein the polygon shape may be a closed loop bounded by a finite chain of line segments, such as, without limitation a triangular shape 305, square shape 315, rectangular shape 310, octagonal shape 320, trapezoidal shape 325, hexagonal shape 330, a concave shape, a convex shape, a rhomboidal shape, quadrilateral shapes, polygram shapes such heptagram, hexagram, pentagram, enneagram, decagram, hendegram, docecagram, n-grams (alternative word to polygram where n may be any positive number of sides), polygon shapes such as, and without limitation, pentagon, hexagon, octagon, decagon, dodecagon, digon, nonagon, hendecagon, tridecagon, tetradecagon, pentadecagon, hexadecagon, heptadecagon, octadecagon, enneadecagon, icosagon, icositetragon, triacontagon, tetracontagon, pentacontagon, hexacontagon, heptacontagon, octacontagon, enneacontagon, hectogon, chiliagon, myriagon, megagon, apeirogon and any other polygon with any number of edges, n-gon shapes (where n may be any positive number of sides) and polyhedral shapes such platonic solids, tetrahedron, cube, octahedron, n-hedron (where n may be any positive number of sides), other variations of polygons, such as, and without limitation, equilateral shapes, simple polygons, and complex polygons, wherein n may be any positive number integer and may identify a number of sides. In another embodiment, the cornered shape may be a substantially irregular polygon shape, such as, without limitation, irregular star shape 335. In some embodiments, a cornered shape may include at least one generally curved side, such as, without limitation, curved shape 340, convex shapes, half circle shape 345, half ovals, oval, or concave shapes thereof. Furthermore, the curved side may be concave or convex. In another embodiment, an implant device may not be a circle or oval in a top view cross section. It is contemplated that regular and/or irregular polygon shapes or cornered shapes for the implant device may provide locking retention when joined to some prosthetics because corners may not allow the prosthetics to rotate.

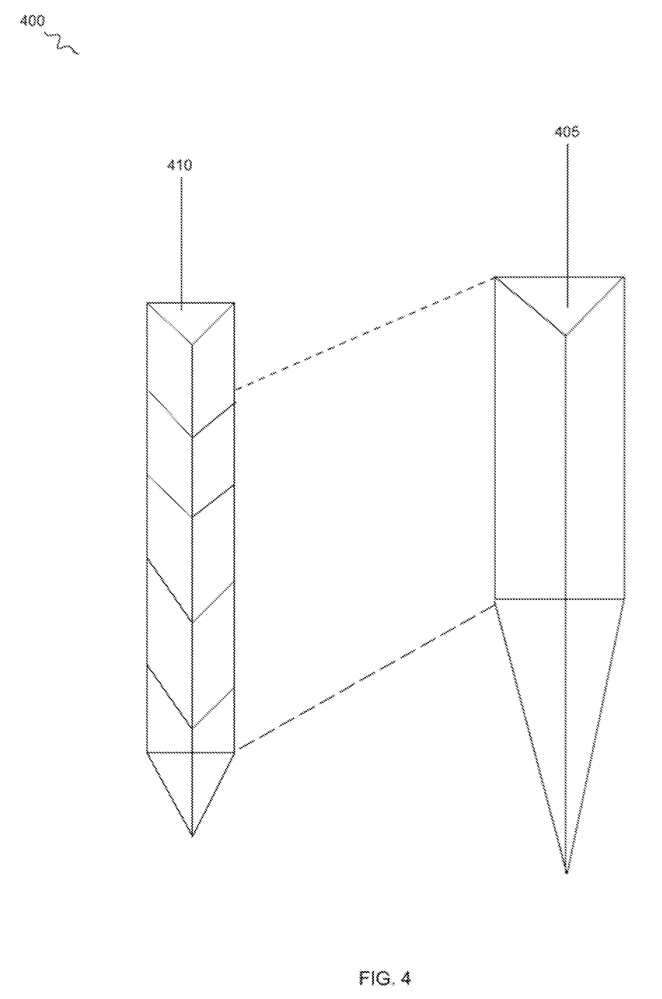

FIG. 4 illustrates a side view of an exemplary alternative embodiment of an implant device 400, in accordance with an embodiment of the present invention. In the exemplary alternative embodiment, implant device 400 may comprise a wedging edge portion 405, wherein the wedging edge portion may be configured to extend down from a portion of the implant device and the portion may be below a top portion 410 of the implant device.

In many alternative embodiments, the biocompatible material of the implant device implant may comprise one or any combination of, without limitation, zirconia, titanium alloy, ceramic, dental porcelain, bone, gold, hydroxyl-apatite, stainless steel, platinum, cobalt chrome (CoCr), nitinol (NiTi), exotic alloys, aluminum, brass, metals and polymers; including, without limitation PEEK, polyethylene (UHMWPE) and radel, and substantially any material that may permit the use of an implant prosthesis in the human body. In many embodiments the implant device may comprise a one or multiplicity of shades of zirconia, wherein the multiplicity of shades of zirconia may include, without limitation white, translucent, transparent, or a clear color suitable for the needs of a particular application or esthetic features. Furthermore, the multiplicity of shades may range from, for example, and without limitation, classical, 3D, bleach, or based on any shade guide well-known in the relevant art. In another alternative embodiment holes may include stem cells to further generally aid in bone growth by being able to be applied directly to a wound site, wherein, stem cells may help with new bone growth, filling gaps and allowing healing and restoration. In yet another alternative embodiment, the holes may be of a multiplicity of shapes, sizes, and amounts. In another alternative embodiment, a surface of the implant device may be a smooth or ridged texture. In another embodiment, an implant device may be configured to not include any holes. In another alternative embodiment a surface treatment of the implant device may include, without limitation, laser blasting, grit blasting, ion bombardment, passivation, or hydroxyapatite coating.

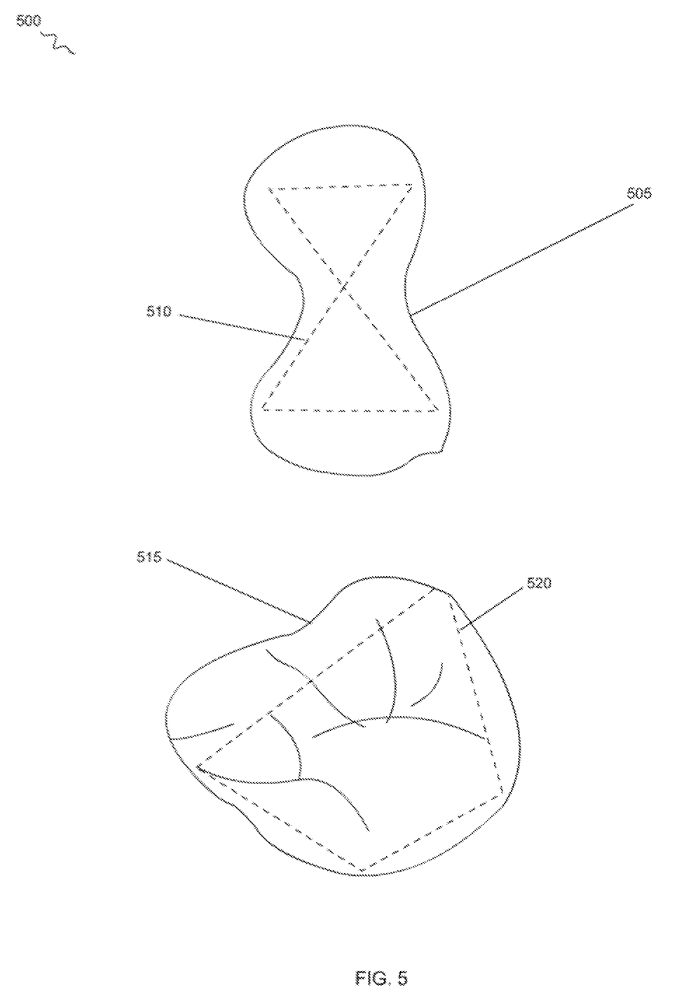

FIG. 5 illustrates exemplary shape approximations 500 of a posterior tooth and a posterior root, in accordance with an embodiment of the present invention. In the present embodiment, a shape of an implant device may be selected to optimally approximate exemplary, without limitation, approximate posterior teeth shapes. The illustration of FIG. 5 exemplifies a cross section of a natural maxillary premolar root 505, wherein the cross section of the natural maxillary premolar root may more accurately be approximated by polygonal shape 510 than a perfect circle. Moreover, the illustration of FIG. 5 also exemplifies a natural crown portion of a maxillary molar 515, wherein the natural crown portion and occlusal table of the maxillary molar may also be more accurately approximated by polygonal shape 520 than a perfect circle. It is contemplated that those skilled in the relevant art will readily recognize that some teeth and roots may not be generally circular and may, instead, be generally polygonal in shape, and therefore, it may be contemplated that a polygonal substructure of an implant device may disseminate forces more equally than a circle. Furthermore, once the implant device is placed, there may be more room buccal/facial-lingually to make a custom fabricated crown or an angle custom crown, to possibly fit a local environment than with conventional bulky substructures.

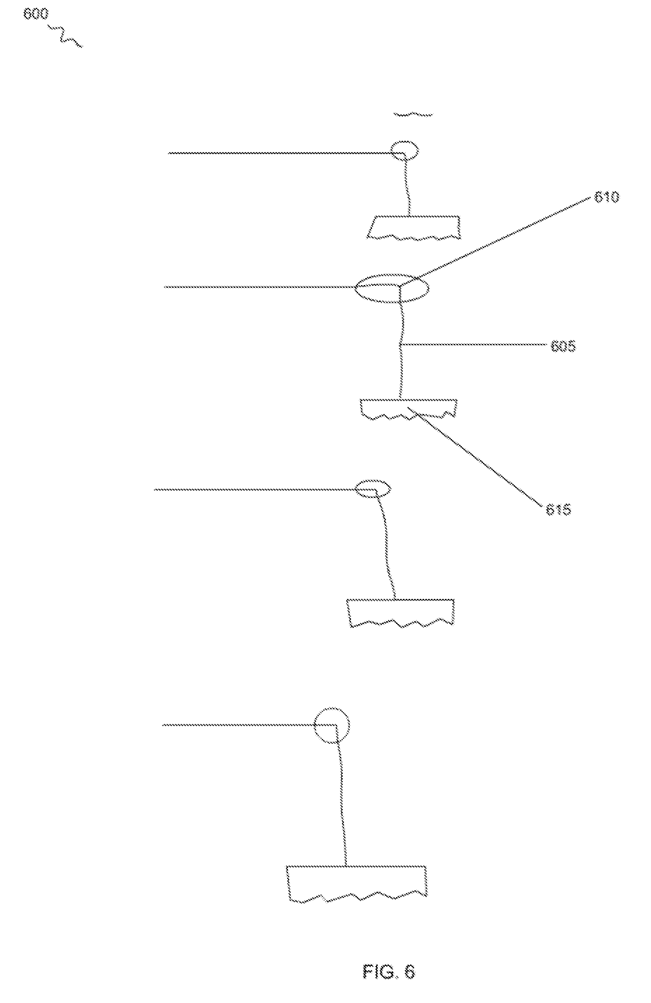

FIG. 6 illustrates an exemplary depth implementation 600 of some exemplary embodiments of an implant device, in accordance with an embodiment of the present invention. In many embodiments, an exemplary, without limitation, implant device may be installed at a multiplicity of different exemplary, without limitation, depths 605 with respect to a soft tissue edge 610. In many embodiments, the implant device may be installed to depths in an exemplary, without limitation, range of 5 mm to 30 mm. Furthermore, the implant device may be installed using well-known instruments such as, without limitation, ridge split chisels, piezo dental instruments, dental burs, lasers, handpieces, mallets and well-known vibration methods such as an ultrasonic device. Most dental offices may already have a dental mallet in their armamentarium but it may or may not fit the protocol. In the present embodiment, apical end portion 615 of the implant device may be driven, at least, 5 mm into bone to create a slit in order for the implant device to achieve a desired stability as inserted and prevent slipping during the process.

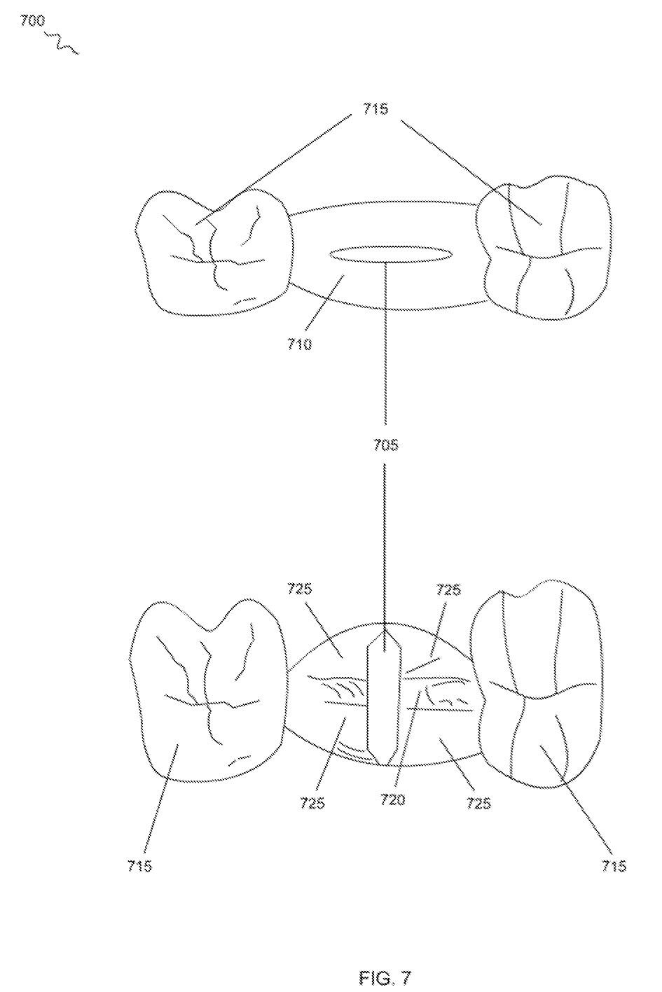

FIG. 7 illustrates exemplary implementations of an exemplary embodiments of an implant device 700, in accordance with an embodiment of the present invention. In many embodiments, implant device 705 may be placed in an exemplary, without limitation, centralized position, wherein the centralized position may be centered between underlying bone 710 and adjacent teeth 715. In some embodiments implant device 705 may be placed in an exemplary, without limitation, off-center position for needs suitable as may be required by particular applications. In the present embodiment, the centralized and off-center position may include being orientated in parallel to a distal-mesial direction, so that wedging edge portions of the implant device point towards adjacent teeth. In an alternative embodiment, a centralized and off-center position may include being oriented perpendicular to the distal-mesial direction, so that wedging edge portions point perpendicular to the adjacent teeth. In some other alternative embodiments, a centralized and off-center position may include substantially any orientation between 0 degrees and 180 degrees with respect to a distal-mesial direction, and thus allowing for 360 degrees sagittal (vertical or frontal plane) placement rotation of an immediate implant in an immediate extraction socket. In some embodiments, in accordance with an embodiment of the present invention, the dental implant may also provide vertical and/or horizontal augmentation support. In some cases, a bone ridge 720 may be very narrow and/or atrophied. In some embodiments, the dental implant device may be placed at substantially any orientation between 0 degrees and 180 degrees with respect to a distal-mesial direction for the needs of the particular application, essentially, the dental implant may be inserted so that the wedging edge portions may engage walls of an extraction socket, wherein a placement of the dental implant may also be turned 90 degrees (Buccal/Lingual) and the wedging edge portions may point buccal-lingual instead of mesial-distal, or anywhere in between in accordance with any angle rotation angle of placement. Furthermore, after insertion of a minimum of 5 mm into bone, all adjacent areas, wherein a sampling may be denoted as a multiplicity of area 125, may be grafted with bone horizontally and/or vertically to recover lost bone. Moreover, the change in rotational and/or angulated placement (median, frontal, sagittal and transverse plane) may be accommodated for in the final restoration (i.e. crown).

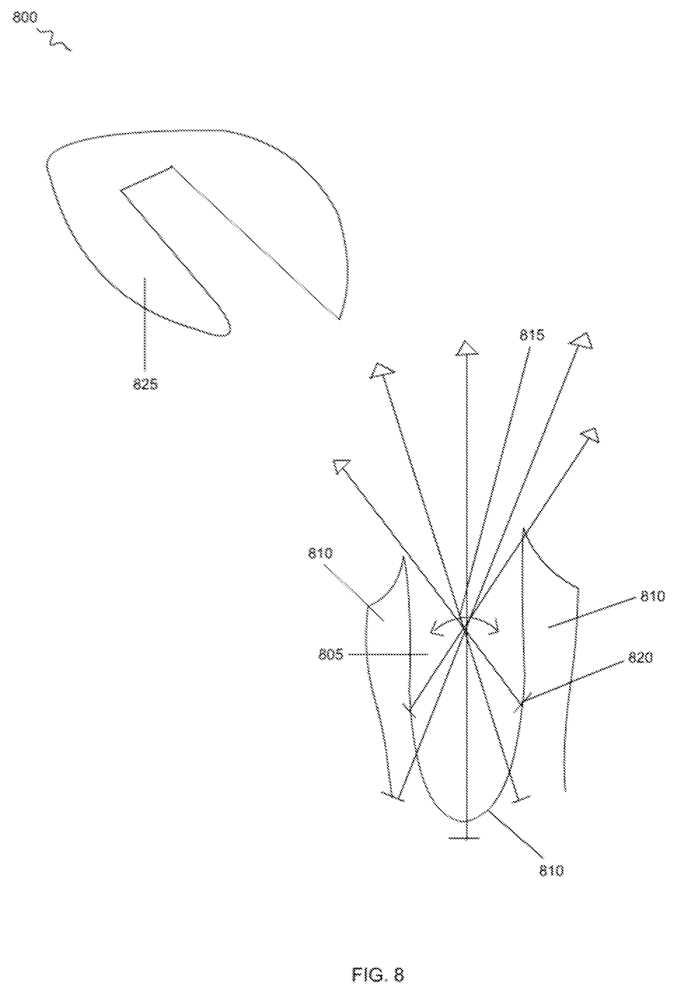

It is further contemplated that conventional round circumferential implants may not allow for angulation flexibility due to an additional bulk, therefore conventional implants may need angled abutments, screws and other components that may typically be the cause of implant failure (i.e. fatigue or mechanical failure). FIG. 8 illustrates an exemplary angular depth implementation 800 of an exemplary embodiment of an implant device, in accordance with an embodiment of the present invention. In many embodiments, an implant device may be installed within the bony socket 805 and hard tissue 810 at particular angle 815 of a multiplicity of suitable angles. Furthermore, the implant device may comprise an exemplary, without limitation, optimal thickness range, and an exemplary, without limitation, optimal width range, and an exemplary, without limitation, optimal height range that may allow for a variable angulation installation, wherein the implant device may be installed at one of a multiplicity of different exemplary, without limitation, angles. Width and thickness may be between 2 mm-20 mm in MIN/MAX range. It should be noted that the height may range from 6 mm-50 mm in MIN/MAX. A variable range of angulation may be with respect to a coordinate reference system that may include a perpendicular straight line position that may represent zero degrees, wherein the variable range of angulation may be from 0 to +/−45 degrees from the perpendicular straight line position. It is contemplated that more angulations are possible than with conventional implants due to smaller buccal-lingual dimension (thickness—frontal plane) versus distal-mesial (width—sagittal plane) and angled restorations (i.e. crown). In the present embodiment, the implant device may be joined to the surrounding bone and hard tissue at a particular anchor point of a multiplicity of possible anchor points depending on a particular angle of installment of the multiplicity of possible angles, wherein an exemplary, without limitation, sampled anchor point may be denoted as anchor point 820, which may act as a fulcrum dispersing force applied to the implant device into the surrounding bone. Furthermore, each particular angle of installment 815, of the multiplicity of possible angles, may correspond to a particular anchor point. In some practical implementations of the present embodiment, an angulation corrected crown 825 may be joined to an implant device that may be angularly installed or may be fabricated at an accommodating angle (i.e. crown).

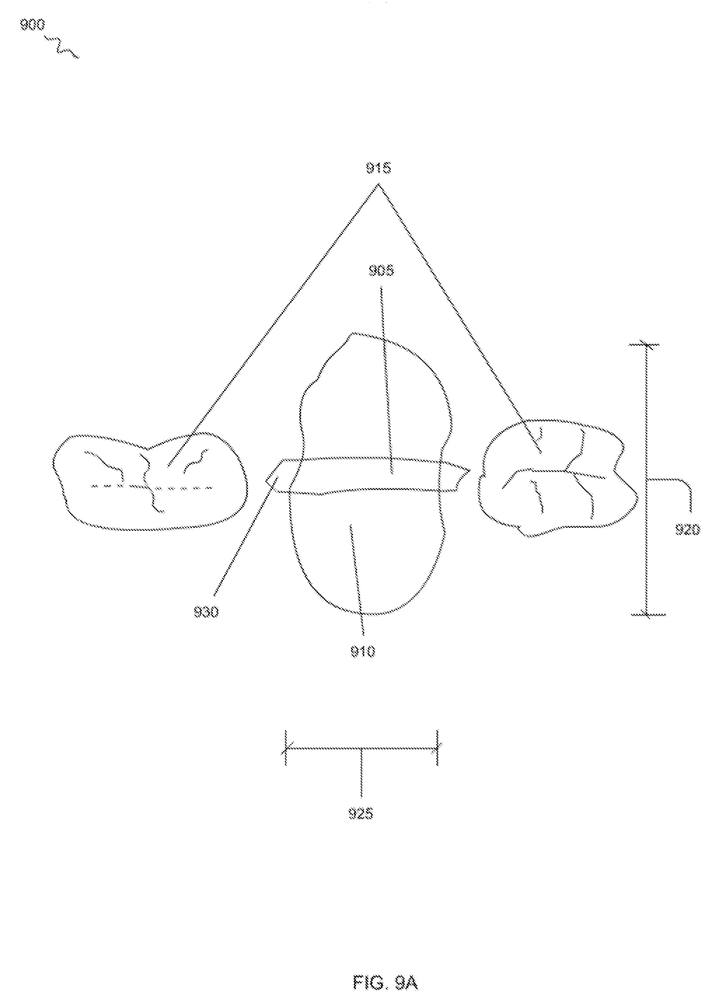

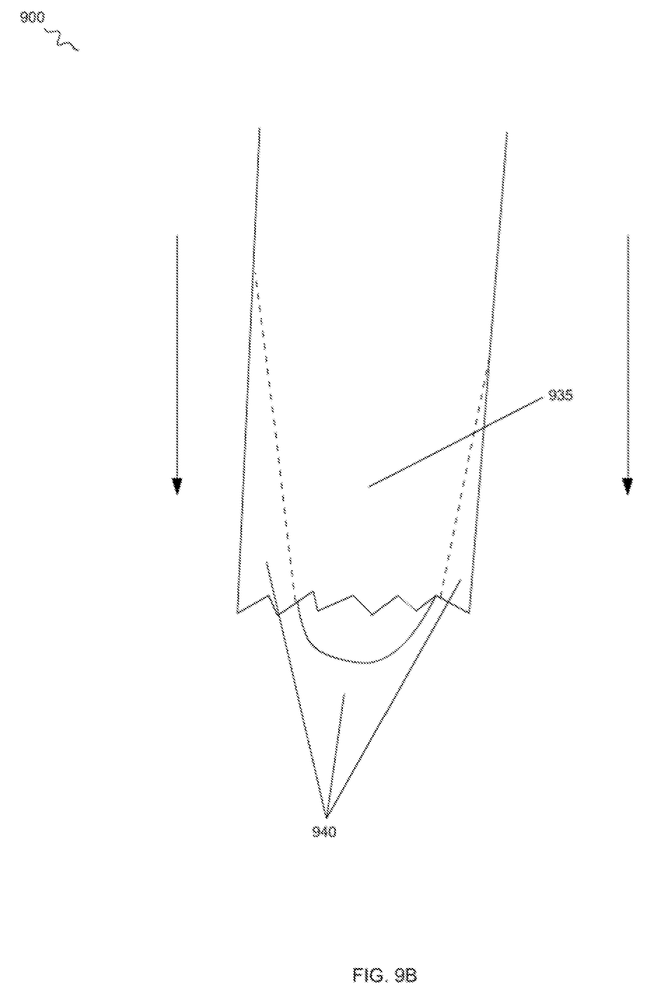

FIG. 9A and FIG. 9B illustrate various view of an exemplary installment implementation 900 of an exemplary embodiment of an implant device 905, in accordance with an embodiment of the present invention, where FIG. 9A illustrates a top view of the exemplary installment implementation. In the present embodiment, implant device 905, may be installed at a centralized or off-central position in an extraction socket 910 between adjacent teeth 915. Exemplary single rooted extraction sockets may typically be larger in a buccal-lingual direction 920 with respect a mesial-distal direction 925. This may allow a multiplicity of beveled wedging edge portion 930 to achieve a strong engagement with surrounding socket walls as gradually inserted. FIG. 9B illustrates a front view of the exemplary installment implementation of the exemplary embodiment of the implant device. In the present embodiment, an apical end portion 935 of the implant device may engage an extraction socket apical portion 940 during installation, wherein the extraction socket apical portion may include bony tissue. Furthermore, apical end portion 935 may be configured to include a serrated, jagged, or smooth pointed edge surface to generally allow a strong engagement to the bone and hard tissue while also possibly expanding a socket ridge upon insertion. In another embodiment, the implant device may not need to expand a socket ridge and may be used as a column for socket grafting and vertical or horizontal bone augmentation. The implant device may be used as a column for socket grafting and vertical or horizontal bone augmentation, wherein an insertion of the dental implant device may depend on anatomical limitations such as, and without limitation, bone density, quality, height, thickness, class of occlusion, and restorative considerations.

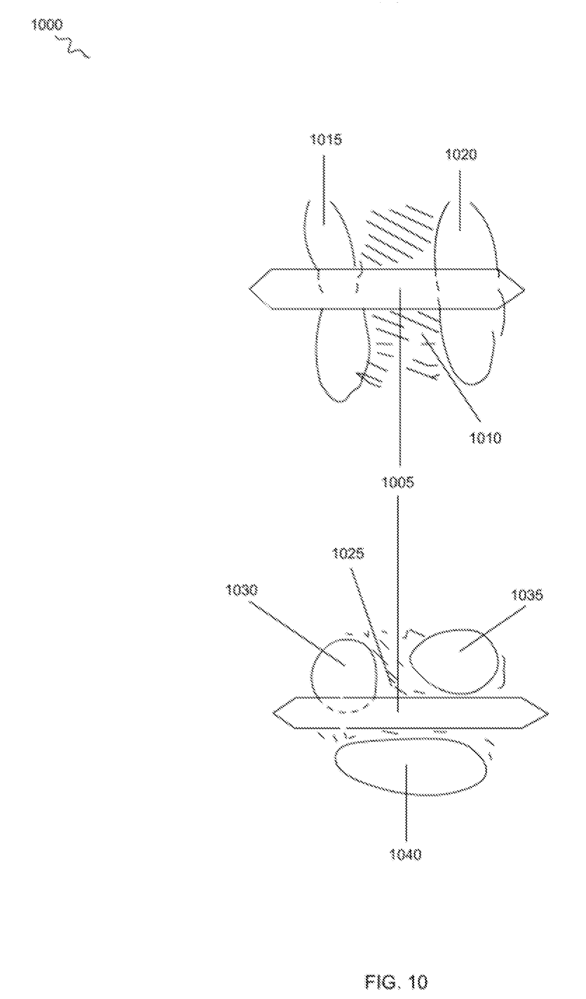

Typically, extraction sockets of mandibular molars and maxillary molars may include a multiplicity of root sockets as opposed to for example, and without limitation, an extraction socket of a canine tooth which may include only one root socket. FIG. 10 illustrates an exemplary installment implementation 1000 of an exemplary embodiment of an implant device 1005, in accordance with an embodiment of the present invention. In many embodiments, the implant device may be inserted in a single natural root socket and/or in a natural multi-rooted socket. In many embodiments, an implant device may also be installed at a centralized and/or off-central position within bone and hard tissue of an exemplary, and without limitation, mandibular extraction socket 1010, wherein the mandibular extraction socket may further include a distal root socket 1015 and a mesial root socket 1020. Those skilled in the art, in light of the present teachings, will readily recognize that the orientation of the implant device with respect to the exemplary labeled distal root socket and mesial root socket may be reversed. Furthermore, in the present embodiment, implant device 1005 may be installed at a centralized or off-centralized position within bone and soft tissue of a maxillary extraction socket 1025, wherein the maxillary extraction socket may further include a maxillary distal root socket 1030, a maxillary mesial root socket 1035, and a maxillary palatal root socket 1040. The distal root socket and the mesial root socket may be on a buccal side (closer to a cheek) and the palatal root socket may be on a lingual side (closer to a tongue). Those skilled in the art, in light of the present teachings, will readily recognize that the orientation of the implant device with respect to the exemplary labeled maxillary distal root socket, maxillary mesial root socket, and maxillary palatal root socket may be reversed. Furthermore, in the present embodiment, an apical end portion of the implant device may initially engage a surface of an extraction socket. In another embodiment, a multiplicity of implant devices may be inserted into a multi-rooted socket. In another embodiment a larger sized dental implant may be place into the multi-rooted socket in interradicular bone. It is contemplated that in the present embodiment, many restorative options may be provided since the dental implant may engage walls on any four walled multi-rooted or single-rooted socket, wherein an insertion of the dental implant device may depend on anatomical limitations such as, and without limitation, bone density, quality, height, thickness, class of occlusion, and restorative considerations. In some embodiments, the apical end portion and/or the wedging edge portions of the dental implant may engage a surface of a socket but parts of the body portion of the implant device may not, until osseointegration occurs in an immediate implant scenario (extraction socket placement).

In some embodiments, in a case that an implant device may be installed in one or more edentulous spaces, the dental implant may optimally be driven a minimum of 5 mm into sound bone. In some other embodiments, in a case that an implant device may be installed in one or more extraction sites, wedging edge portions of the dental implant may optimally engage at least 5 mm of an apical portion of an extraction socket or an extraction root socket. In many embodiments, surrounding spaces may be filled with bone and closed up for healing.

In some alternative embodiments an implant device may include a multiplicity of apical end portions that may engage a multiplicity of root socket apexes during implant device installment.

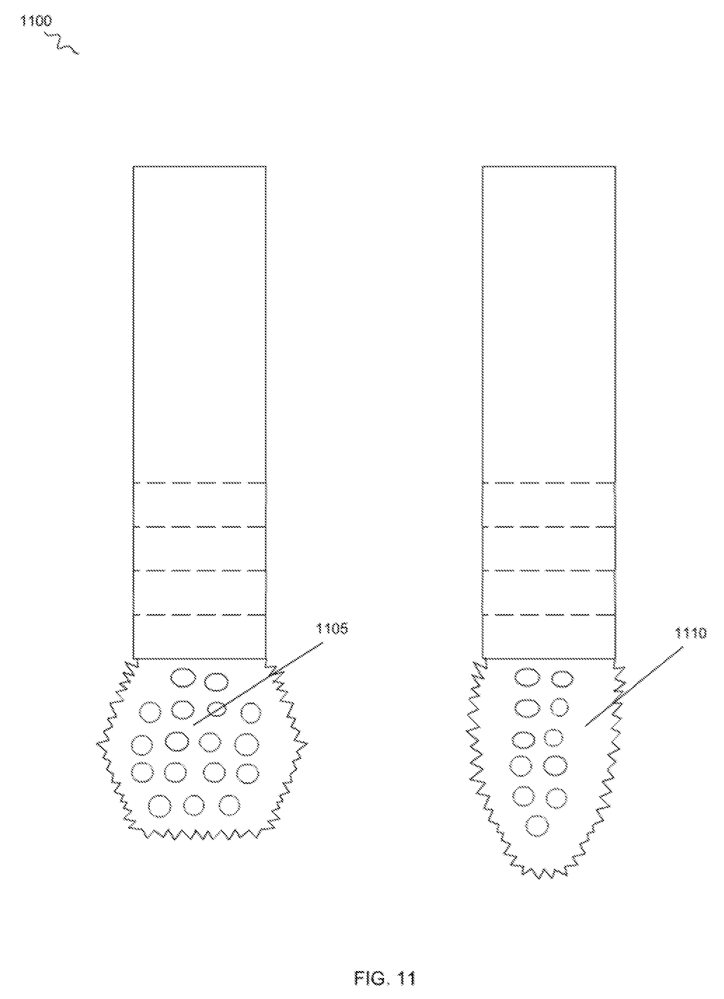

FIG. 11 illustrates an exemplary alternative embodiment of an implant device 1100, in accordance with an embodiment of the present invention. In many embodiments, the implant device may be configured to include an apical end portion, wherein the apical end portion may be configured as an exemplary, without limitation, polygonal shape 1105 or curved shape 1110 and at least one edge of the apical end portion may be serrated or jagged. Furthermore, in some embodiments, a serrated edge may extend around the entire apical end portion. In other alternative embodiments, the apical end portion may include exemplary, without limitation, substantially any regular polygon shape, substantially any irregular polygon shape, a circle, an oval, or substantially any curved line segment shape. In some other alternative embodiments, wedging edge portions and an apical end of an implant device may include holes for additional osseointegration, mechanical interlocking, and to increase surface contact.

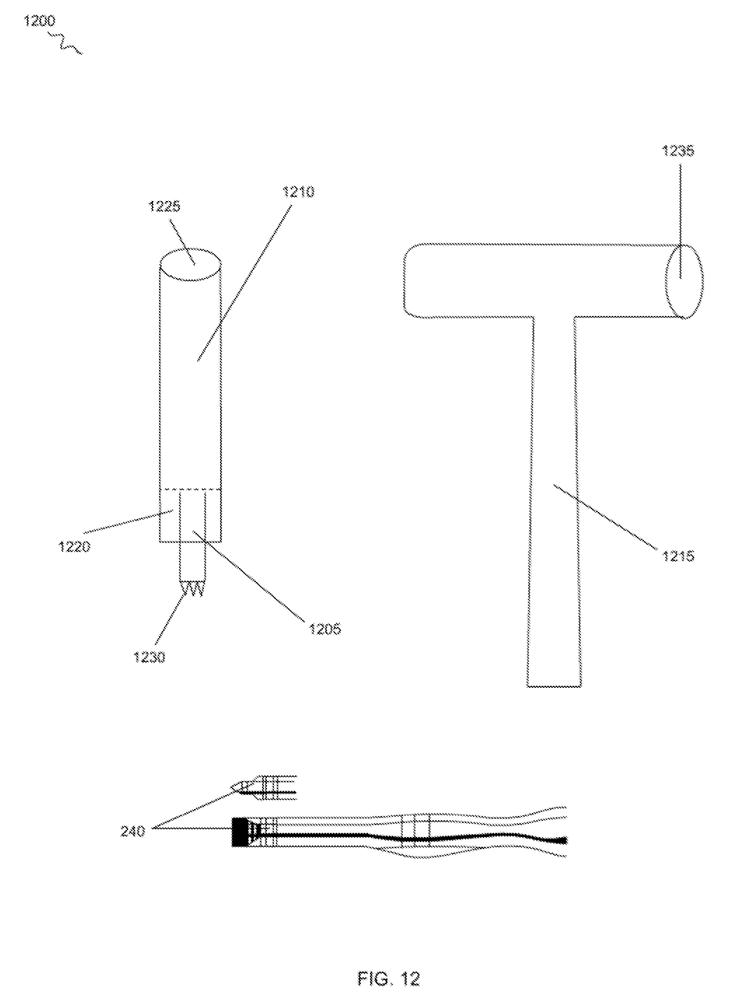

FIG. 12 illustrates an exemplary embodiment of an implant device system 1200, in accordance with an embodiment of the present invention. In the present embodiment, the implant device system may include an implant device 1205, an implant device carrier 1210, and an implant device inserter 1215, wherein the implant device may be removably joined to the implant device carrier. Furthermore, contact may be made between the implant device carrier and the implant device inserter for implant device installation into a desired implant position. Implant device carrier 1215, may include a hollow end portion 1220 and a contact end portion 1225, wherein the implant device may be removably joined to the hollow end portion of implant device carrier 1210 by inserting a top portion of the implant device into the hollow end portion. The joined implant device and implant device carrier may be positioned with respect to a patient so that an apical end portion 1230 of the implant device may be positioned over the desired implant position. Implant device inserter 1215 may include an inserter contact portion 1235, wherein the inserter contact portion may be brought into contact with the contact end portion of the implant device carrier, wherein the contact may drive the implant device into the desired implant position. Contact between the contact end portion of the implant device carrier and the inserter contact portion may be repeated until the implant device has been driven into the desired implant position to a desired depth. Implant device carrier 1210, may be separated from the implant device while the implant device is fixedly joined into the desired implant position. In the present embodiment, the implant device carrier may be a length in a range of 20 mm to 80 mm. Furthermore, the carrier may be comprised of a material such as, and without limitation, rubber, metal, titanium, steel, porcelain, carbon, gold, silver, palladium, platinum, tungsten, carbide, plastic, polymer, alloy, or and any combination thereof. Furthermore, the hollow end portion of the implant device carrier may include a circumferential width that may be 1 mm to 5 mm wider than a width and thickness of the implant device. The circumferential width may allow for a minimal clearance creation for a prosthetic by maintaining a minimum lateral space during the implant device installation, wherein minimum sufficient lateral space may depend on, at least, a particular tooth socket location, and a position of adjacent teeth. A range of lateral space to be maintained may vary between a 2 mm radius to a 50 mm radius. The implant device carrier may also guide a practitioner during installation to generally aid in achieving a desired orientation, angulation, and positioning of the implant device, by the implant device carrier generally providing a 5 mm-50 mm engagement portion at the coronal portion of the implant device, wherein the engagement portion may be a portion of the implant carrier that may engage the implant device to possibly carry, possibly secure, possibly control, and possibly manipulate the implant device throughout insertion. Furthermore, the engagement portion may act as a stop, and thus only allowing the dental implant to be driven to a particular depth the implant device. Moreover, the coronal portion of the implant device may be a top portion of the implant device which may remain above a gum-line after insertion to act as an anchorage for a prosthetic device. The implant carrier may not enter any hard tissue and may act as a stop as a minimum height of 5 mm may be optimally above bone level as anchorage for a prosthesis. The implant device carrier may allow for visibility of placement and may act as a lever for visualization of the final restoration, orientation, angulation, direction of dissipation of forces and axial loading to the bone with respect to a final restoration, such as a crown. Furthermore, the angulation may be adjusted and corrected with the implant device carrier as the implant device may be driven into place by moving the carrier buccally, lingually, or laterally when engaging bone. Furthermore, in the present embodiment, implant device inserter 1215 may be, for example, without limitation, a mallet. The mallet may include a handle portion, a head portion and at least one contact end portion. Furthermore, the mallet may be comprised of a material such as, without limitation, rubber, metal, titanium, steel, porcelain, carbon, gold, silver, palladium, platinum, tungsten, carbide, plastic, polymer, alloy, or any combination thereof. In an alternative embodiment, a handle may be of a first material, a head portion may be of a second material and at least one contact end may be of a third material. In another alternative embodiment an implant device inserter may be an adjustable mallet, wherein, a contact portion may be adjustably angled with respect to a body portion of a mallet to generally aid in angled implant device installments. The implant device carrier may be gently tapped by the mallet to insert the implant device while the implant device carrier may help with achieving proper orientation between each tap. The mallet may minimize the sound of the tap via a noise protective layer including any of the aforementioned such as, and without limitation, rubber. A head of the mallet may be larger in diameter as compared to the implant device carrier. In another alternative embodiment, a hollow end portion of an implant device carrier may be removably joined to the implant device carrier by a joining mechanism such as, without limitation, friction grip, a screw, bolt, magnet, etc. Furthermore, implant device carrier may be removably joined to a multiplicity of different hollow end portions, wherein each one of the multiplicity of hollow end portions may include a different shape that fits a coronal portion of a particular implant device. In yet another alternative embodiment, an implant device carrier may include an engage-release mechanism that may be actuated to lock an implant device into a hollow end portion. The engage-release mechanism may further be actuated to release the implant device from the hollow end portion before or after a desired insertion depth may be reached or before, after, and when enough stability may be obtained. In an exemplary alternative embodiment, an engage-release mechanism may include a switch and lock device, wherein actuating a switch or button on an implant device carrier may cause a protrusion to extend and apply pressure to an implant device inside of a hollow end. In another exemplary alternative embodiment an engage-release mechanism may include twisting an implant device carrier with respect to an implant device, while the implant device may be inside a hollow end portion, in order to cause the implant device to interact with a protrusion or indentation inside the hollow end portion. In yet another exemplary alternative embodiment an engage-release mechanism may be a narrowing space of a hollow end portion that may allow an implant device to become slightly wedged in the hollow end portion. In another embodiment the implant device system may further include an implant device system kit, wherein the implant device system kit may include the implant device inserter (mallet). In many embodiments the implant device system kit may further include a multiplicity of implant device carriers, wherein the multiplicity of implant device carriers may include at least 3 implant device carriers. In many embodiments, the implant device system kit may include a multiplicity of exemplary, and without limitation, ridge splitting chisel 240, wherein the multiplicity of ridge splitting chisels may include at least 3 ridge splitting chisels that may vary in size. In many embodiments, the implant device system kit may further include a multiplicity of implant devices, wherein the multiplicity of implant devices may include a select array of implant sizes. In some embodiments the ridge splitting chisel may be used to create initial slots, wherein the initial slots may be equal to and/or 1 mm smaller, in length and/or width, than an implant device to be installed. In many embodiments, items of the implant device system kit may be sterilize-able. In many embodiments, additional or replacement parts can be distributed separately. In some other embodiments, the implant device system kit may include robotic milling devices and placement guides. In many embodiments the implant device system may include sterile implant packaging.

FIG. 13 illustrate an exemplary alternative embodiment configuration of an implant device 1300, in accordance with an embodiment of the present invention, wherein the implant device may include only one tapered surface. In many embodiments, the tapered surface may be on an apical end 1305 of the implant device. Furthermore, in some embodiment, the implant device may include a textured body portion 1310. In other embodiments, the implant device may not include beveled wedging edge portions.

FIG. 14 illustrates an exemplary embodiment configuration of an implant device 1400, in accordance with an embodiment of the present invention, wherein the implant device may include an apical end portion 1405, and a multiplicity of wedging edge portion 1410. In many embodiments, at least 2 wedging edge portions may be angled by a tapering that end abruptly. Furthermore, in some embodiments, the apical end may be blunt.

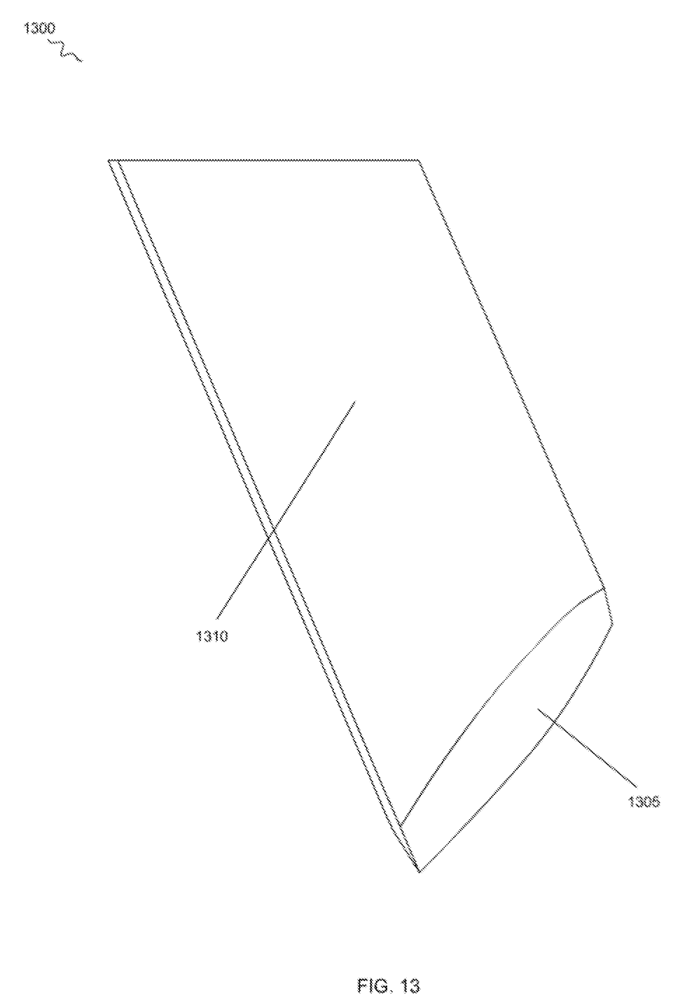

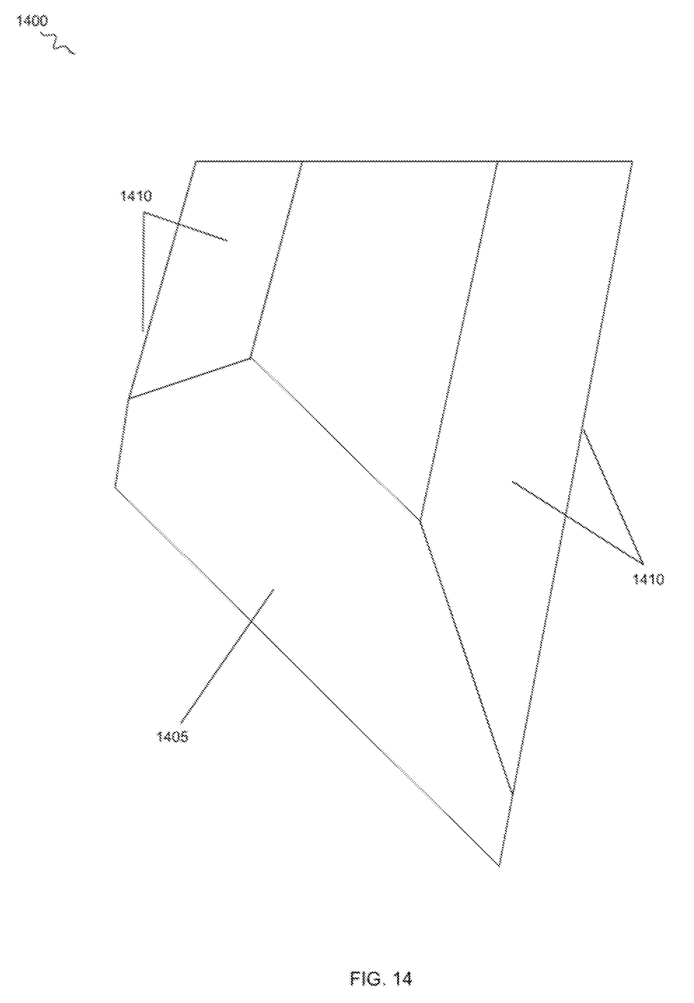

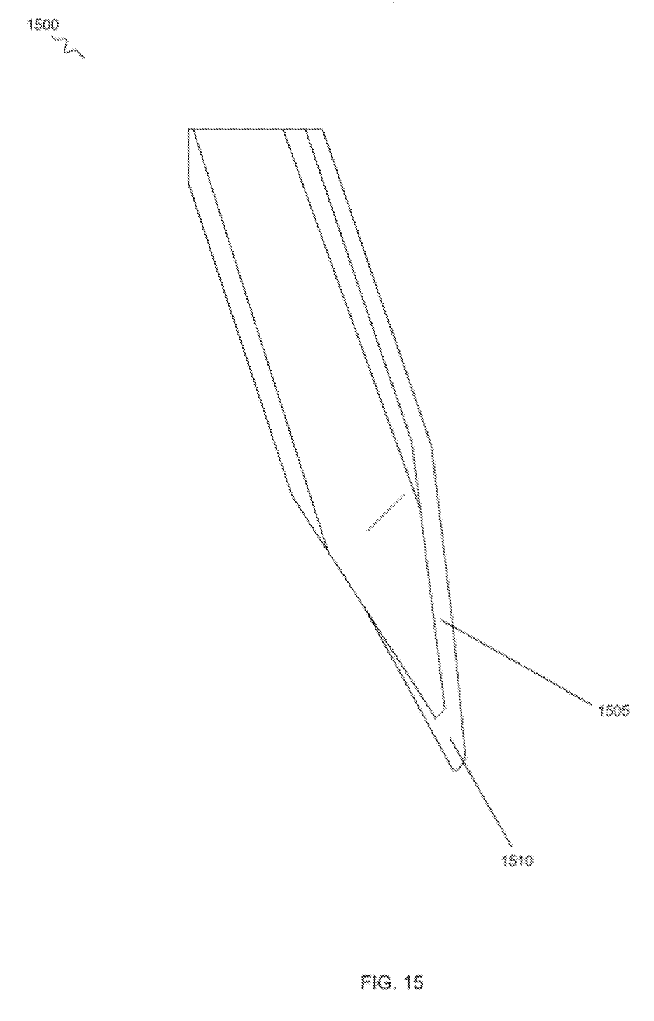

FIG. 15 illustrates an exemplary embodiment configuration of an implant device 1500, in accordance with an embodiment of the present invention. In many embodiments, the implant device may include an apical end 1505 that may be beveled from opposite surfaces such that the apical end may include a sharp edge 1510. In some embodiments, the sharp edge may not be serrated.

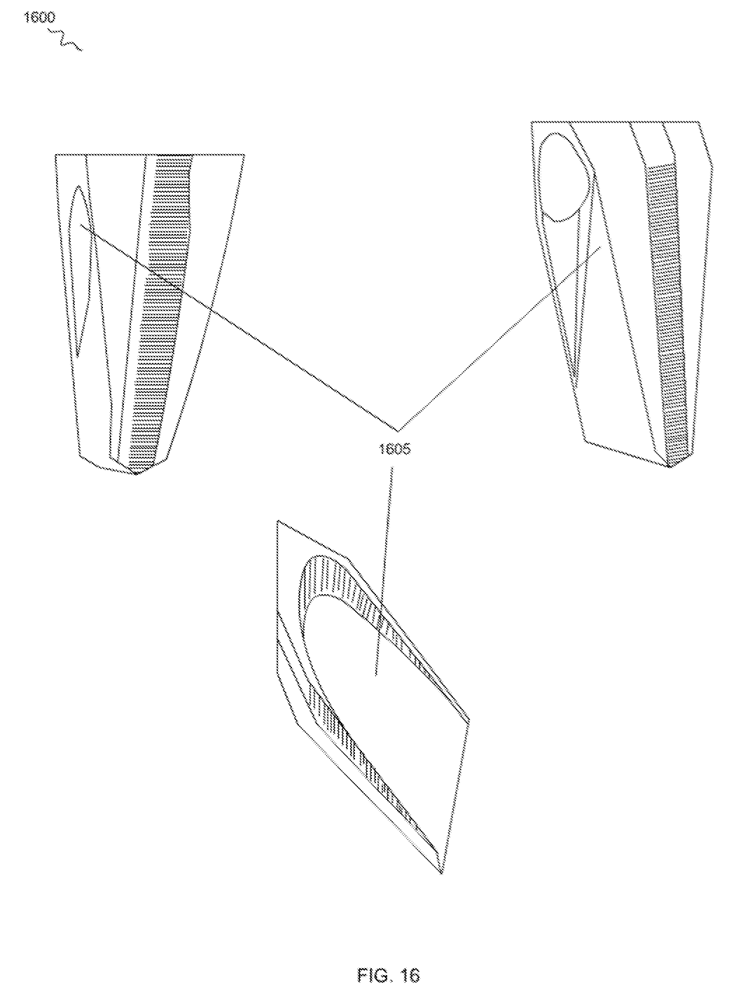

FIG. 16 illustrates an exemplary embodiment configuration of an implant device 1600, in accordance with an embodiment of the present invention. In many embodiments the implant device may include an indented body portion 1605. Furthermore, the implant device may include a thickness, wherein a thickness at a bottom portion of the implant device may be less than a thickness at a top portion of the implant device. In some embodiments, the implant device may be configured to include a gradual tapering.

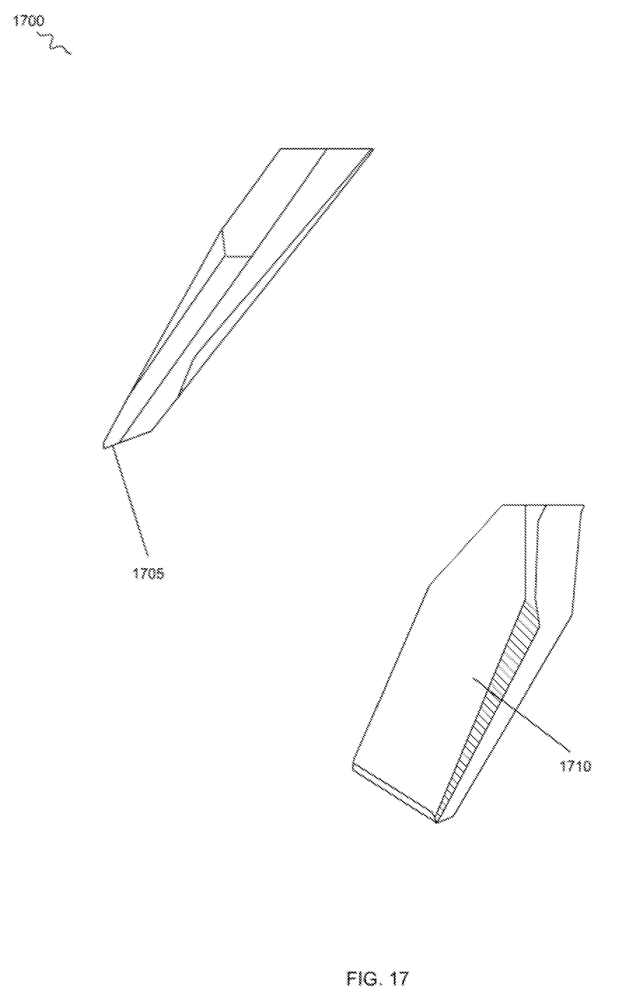

FIG. 17 illustrates an exemplary embodiment configuration of an implant device 1700, in accordance with an embodiment of the present invention. In many embodiments, the implant device may be configured to include a top portion that may be a larger thickness than a bottom portion. In some embodiments, the implant device may further be configured to include a gradual tapering and a steep tapering. In many embodiments, an apical end 1705, of the implant device, may include the steep taper. Furthermore, in some embodiments, a wedging edge portion 1710 of the implant device may be partially beveled

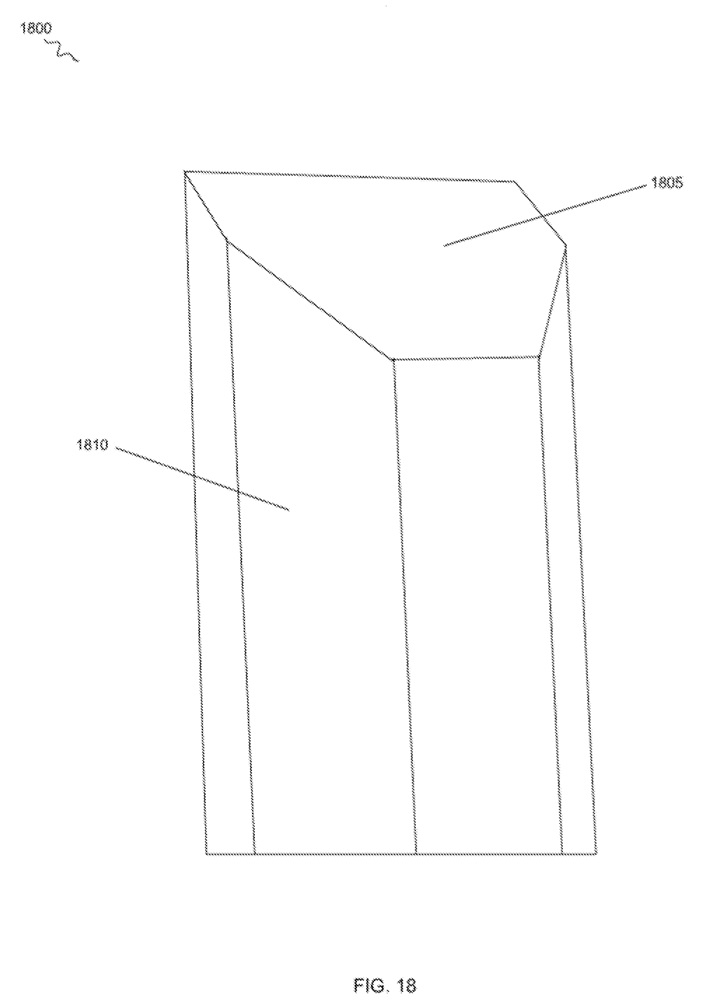

FIG. 18 illustrates an exemplary embodiment configuration of an implant device 1800, in accordance with an embodiment of the present invention. In many embodiments, the implant device may include a beveled apical end portion. Furthermore, in some embodiments, the beveled apical end may further include a curved surface 1805. In yet still more embodiments, a bevel wedging edge portion 1810 of the implant device may end abruptly.

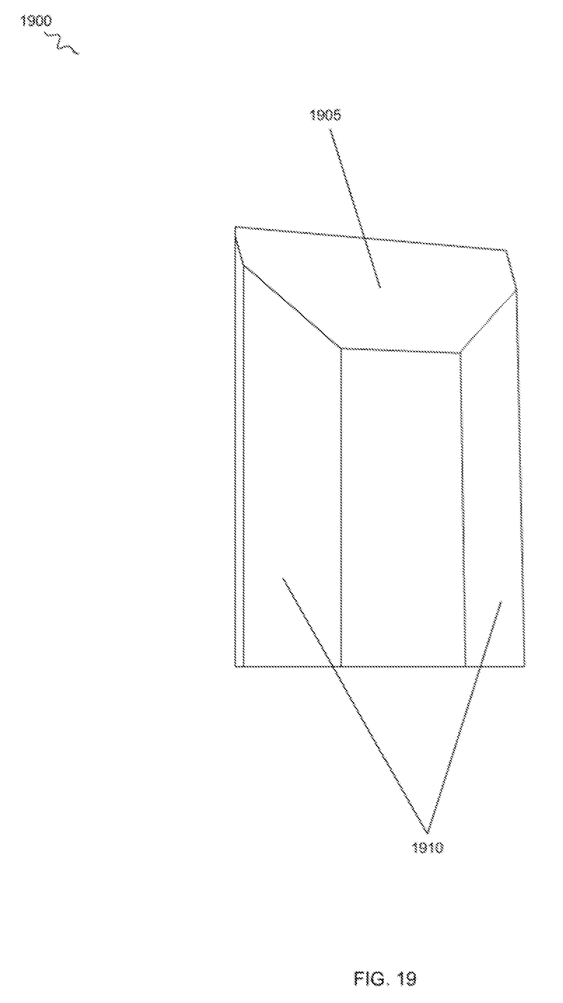

FIG. 19 illustrate an exemplary embodiment configuration of an implant device 1900, in accordance with an embodiment of the present invention. In many embodiments, the implant device may include an apical end portion 1905 and a multiplicity of wedging edge portion 1910, wherein the apical end portion and the multiplicity of wedging edge portions may be bevel to include sharp edges.

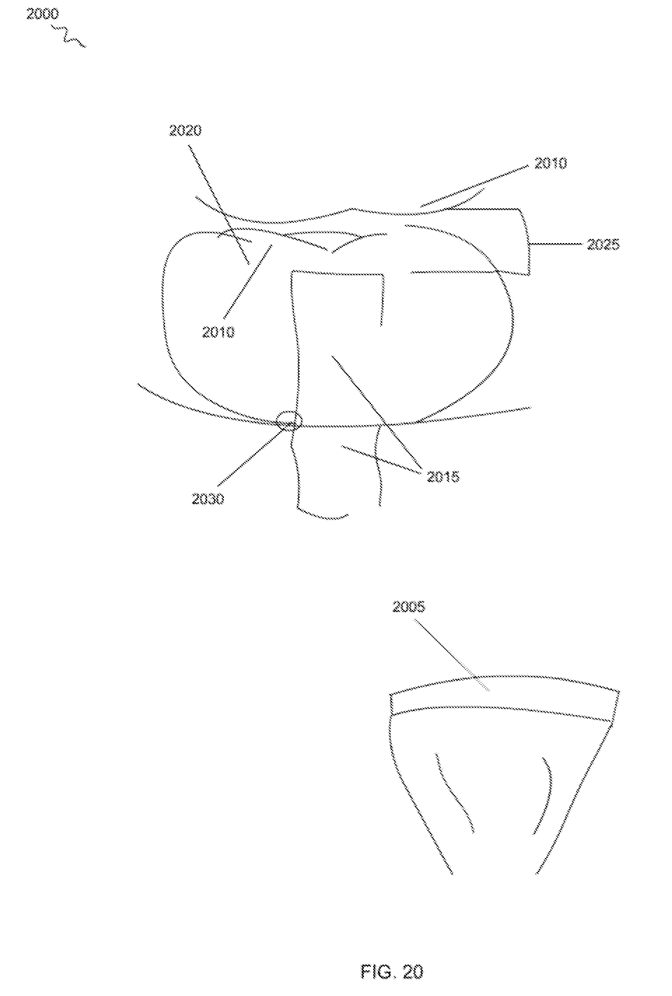

FIG. 20 illustrates exemplary surfaces and clearances of an exemplary tooth and crown fitted to an exemplary implant device, in accordance with an embodiment of the present invention. In present embodiment, as an illustrative example, at least, teeth and other dental prosthetics may include an incisal surface 2005 or occlusal surface 2010, (depending on where the tooth is located in the mouth), wherein the incisal and occlusal surfaces may include a biting surface. Furthermore, an installed implant device 2015 may be fitted with a crown 2020, or substantially any other dental prosthetic, wherein the installed implant device may be installed to a depth to allow a distance to be maintained between the installed implant device and a vertically opposing tooth. Moreover, the distance may be an optimal occlusal clearance 2025, wherein the optimal occlusal clearance may be between a top portion of the implant device and an occlusal surface of the vertically opposing tooth. Furthermore, the optimal occlusal clearance may be at least 1.5 mm, wherein, the optimal occlusal clearance may provide an optimum space for crown 2020, in a case that the crown may be configured to be at least 1.5 mm in thickness in occlusal surface. As illustrated, in the present embodiment, the implant device may provide anchorage for the crown and the crown may be joined to the implant device at a 1-90 degree angle 2030 to provide marginal seal and a suitable emergence profile. In many other embodiments the implant device may be fabricated and installed at multiplicity of angles while maintaining an optimal occlusal clearance and the crown may be fabricated to fit the multiplicity of angled implant devices. In the present embodiment, FIG. 20 also illustrates that teeth and dental prosthetics may have a polygonal shape.

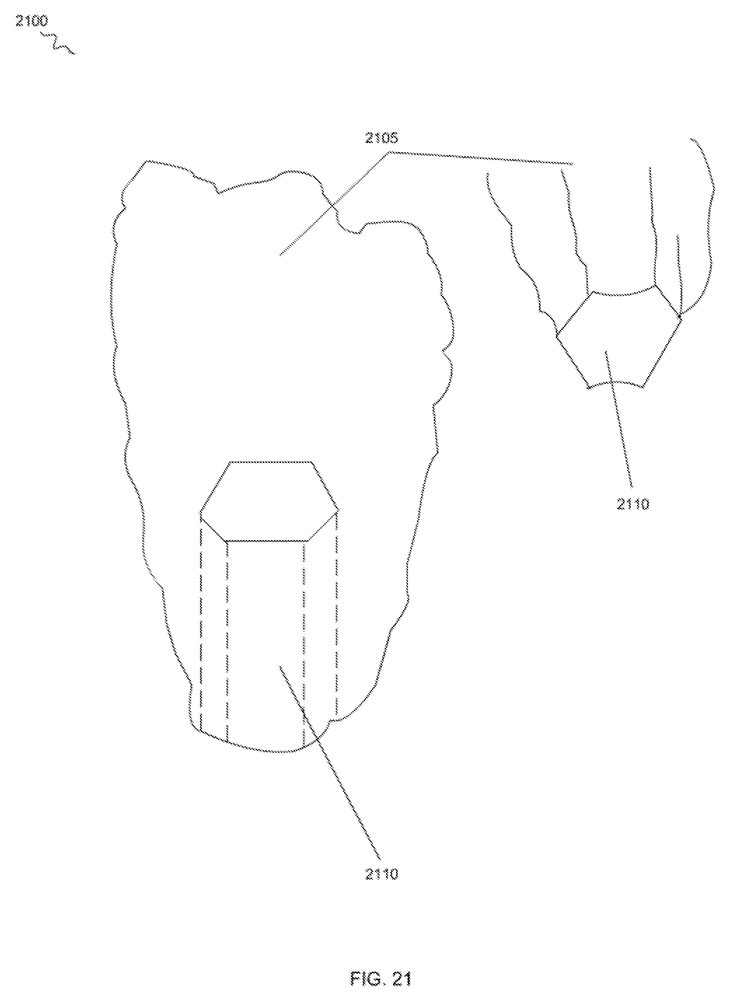

FIG. 21 illustrates exemplary dental prosthetics, in accordance with an embodiment of the present invention. In the present embodiment, a crown 2105 may be configured to include a joining portion 2110, wherein the joining portion may further be configured to be polygonal in shape to allow for a secure fitting to an implant device. The polygonal shape may also provide for better locking retention with the implant device. Furthermore, the crown may be custom made to fit substantially any cross dimension of an implant device described in accordance with an embodiment of the present invention. The occlusal clearance may be checked to determine if there may be enough clearance (i.e. 1.5 mm minimum) to make space for a for a final crown as the final crown may optimally be a minimum of 1.5 mm in thickness in any occluding surface. A bur can be used to prepare the coronal portion of the implant device for its final shape or form and adequate clearance, if necessary

FIG. 22 illustrates a flowchart 2200 of an exemplary method of fitting a crown to a patient, in accordance with an embodiment of the present invention. A first step of the present embodiment may begin with a step 2205, wherein a patient may be anesthetized. Next, in a step 2210, a dental bur, ridge split chisel, or piezo dental device may be used to make an initial 1 mm-5 mm mid-crestal, inter-radicular, and/or intra-radicular slit into the bone after the soft tissue may be incised with a blade and slightly reflected to located the center or top of the bone slit on an edentulous site, wherein a slit length may optimally be equal to and/or 1 mm smaller in all dimension than an implant device to be inserted depending on local anatomy and restorative consideration. In some embodiments the slit length may be between 2 mm-49 mm and a slit width may also be between 2 mm-49 mm. In a step 2215, an exemplary, without limitation, implant device, in accordance with an embodiment of the present invention, may be placed in the slit. An X-ray may be taken for verification of an initial placement of the implant device. Afterwards, in a step 2220, an exemplary, without limitation, implant device carrier and an implant device inserter, in accordance with an embodiment of the present invention, may be used to insert the dental implant by driving the implant into a proper orientation and position. The implant device may also be driven to a desired depth, which may be checked by observing visual height markings on the dental implant device. A desired depth may include a minimum initial depth at which there may be no buccal lingual or mesial distal movement or rotational movement of the implant device. Next, in a step 2225, a stability of the inserted implant device may also be checked, wherein the checking may include gently wriggling the implant device carrier and possibly assuring initial stability. In many embodiments, an initial stability may be considered to be achieved when there may be no buccal-lingual or mesial-distal movement or rotational movement of the implant device. When a minimum initial stability may be reached, the implant carrier may be easily removable from the implant due to its friction grip. The implant device may now be determined to be stable, and thus successfully installed. In the present embodiment, the implant device may be further secured by mechanical retention or permanent cementation. After the implant device may have been further secured, an occlusal clearance may be checked next in a step 2230. The occlusal clearance may be checked to determine if there may be enough clearance to make space for a final crown, wherein enough clearance may be at least 1.5 mm. It is contemplated that in some embodiments the crown or a temporary may not be fabricated without having an adequate occlusal clearance. Moreover, in many embodiments the final crown may be minimally 1.5 mm in thickness in substantially any occluding surface. A bur may be used to prepare a coronal portion of the implant device for its final shape or form and adequate clearance, if necessary. The installed implant device may be optimally stable and locked without any rotational movement. Any recession of bone and soft tissue may be accommodated for by accurate placement of margins of the crown where the final esthetic features will be determined. If acceptable stability is achieved upon placement, a final crown may be made and may be joined to the installed implant device at the same time and within 24 hours of the implant device installation in the step 2230 to complete the treatment. In a case that an initial stability may not be achieved, and a height of interradicular bone may not impede further insertion, an additional insertion may be possible, in a step 2235, by continuing to tap the implant device carrier with the implant device inserter. In some embodiments, the implant device carrier and the implant device may be driven until at least 5 mm of the implant device may be above the bone. In yet another embodiment, the implant device carrier may not allow further insertion past a particular depth, wherein a minimum of 5 mm of the implant device may optimally stay above the bone and further insertion may be stopped by the implant carrier “A Stop.” Thereafter, in the present embodiment, the stability may be checked again. In a case that a height of interradicular bone may impede further insertion, and/or the implant device carrier may not allow for further insertion and the implant device is not rotationally and vertically stable, a temporary crown may be fabricated and removably inserted to further stabilize and allow healing over installed implant devices, teeth, and edentulous sites, in a step 2240. Temporary dental prosthetics may be configured to protect an implant site, installed implant devices, teeth, edentulous sites, facilitate osseointegration of the implant device, and also may distribute essentially full mouth forces, therefore generally allowing a patient to perform typical oral activities such as, without limitation, eating and talking. Temporary crowns may be fabricated immediately (via the persons existing mold taken with a preliminary impression) after a preparation is made or prefabricated temporaries can be used to immediately restore a site. Prefabricated temporaries come in a variety of tooth shapes and sizes and would be adjusted to fit the local environment and requirements for functional and esthetic purposes. Temporaries may be made from stainless steel, composites, resins, gels, acrylics, light cured material, time cured material, dual cured material, base and catalysts, rubbers, porcelains, and metals. They may be cemented with a temporary cement and a temporary purpose such as healing or fabrication of a crown in a lab. Temporaries should be minimally occluding or taken out of occlusion (nonocclusal temporary loading) during this period to prevent macro movement of the implant device. It may be contemplated that an interlocking of the temporary between two teeth would create an additional bilateral stabilization for the implant device for that timeframe. It is preferred that a temporary is designed to guide healing and maintain existing gingival architecture to provide for the best esthetic and functional outcome, especially in the esthetic zone. In the zirconia implant device case, slight recession may not be as noticeable as with a metal substructure, especially with abfraction lesions and Class V cases. In advanced technology capable practice, a Cerec milling machine may be used to mill a permanent crown in the office; thus potentially eliminating the need for a temporary unless acceptable stability is not achieved. In case of temporary fabrication, an impression for a crown may be taken after a waiting period, wherein the waiting period may be 4-6 months allowing for osseointegration. Upon healing of the soft and hard tissues, the portion of the implant exposed may serve as the anchorage for a permanent crown. The gingival margin will be set at this stage. Conventionally, when teeth are prepared for a crown, a feather, chamfer, a bevel, or edge is made at or below the gingival margin when the crown edge will join to create an impermeable seal. It may also be typical practice for implant abutments to have a predetermined margin that may be further prepared in the mouth for optimal esthetic and functional consideration. In a step 2245, a crown made from the impression may be joined to the installed implant device. In an alternative embodiment, a crown may be configured to be removably joined to an installed implant device. Furthermore, in another alternative embodiment a final crown may be made and may be joined to the installed implant device milled immediately and permanently cemented within 24 hours of the implant device installation. In some embodiments, the implant device may be a same color as a tooth, transparent, translucent, or match the color of gum tissue, or denture and may possibly provide an esthetically desired design if recession of a gum line were to occur.

FIG. 23 illustrates a flowchart 2300 of an exemplary method of installing an exemplary, without limitation, implant device, using an exemplary, without limitation, implant device system as illustrated in FIG. 12, in accordance with an embodiment of the present invention. In a step 2305, an implant device 1205 may be removably joined to an implant device carrier 1210, wherein at least an apical end portion 1230 of the implant device may extend out of the implant device carrier. The device carrier may set the maximum stop of insertion where a minimum of 5 mm of the apical portion of bone is engaged in bone. Next, the implant device carrier, joined to the implant device, may be carried to an approximate location of a desired implant site, in a step 2310, so that the apical end portion may be aligned to a desired implant position and orientation at the desired implant site or a pre-created slit via a bur, the ridge split chisel, or a piezo. Then, in a step 2315 a downward force may be applied to the implant device carrier via the implant inserter, thus inserting the apical end portion of the implant device into a slit made on the desired implant site into an apical direction. Next, while the implant device carrier may be held, an implant device inserter 1215 may be used, in a step 2320, to repeatedly tap a contact end portion 1225 of the implant device carrier. With each tap, and with the carrier serving as a parallelism tool or guide, a clinician may continue to direct angulation and proper insertion. In a step 2325, the implant device carrier and the implant device may be driven downward by each tap. The implant device carrier may be configured to not access the bone by its end potentially serving as a vertical stop, so that a minimum of 5 mm of the implant device may remain in the oral cavity above the bone. The implant device carrier may also be configured to prevent over tapping. The implant device may be driven deeper into the desired implant site in increments (the implant markings in combination with verification x-rays may provide an optimal predictable outcome in orientation, placement, and restorative success), and simultaneously, an outer surface of the implant device carrier may create an optimal lateral clearance for the final restoration (i.e. a crown) to fit the implant anchorage. Then, a desired implant depth may be checked for, in a step 2330, by identifying a visual height marking on the implant device. When a desired visual height marking may be identified and its location also verified by x-ray, tapping may then cease, and the implant device carrier may be removed from the implant device in a step 2335. The installation of the implant device may be acceptably successful. If a desired visual height marking may not be identified, tapping may continue until a desired visual height marking may be identified. If the desired length is reached but there is not enough occlusal clearance, a dental bur may be used to reduce to coronal portion to achieve clearance for a temporary or permanent prosthesis. In the present embodiment, an optimal lateral clearance may include a distance larger than a width of a prosthetic, wherein the prosthetic may be at least one crown. In a vast majority of cases, a temporary or permanent crown may be put on a single implant unless for removable appliances, where the implants may serve as anchorage points, or latch into a housing placed inside the denture, or when multiple implant devices cross arch and serve as a substructure (bar bridge) where a denture sits on and latches onto the bar (i.e. via a clip). Applicable prosthetic types that may be fitted to the implant device include, without limitation, removable tooth and tissue supported partial dentures (RPD), removable complete dentures (RCD), tooth-tissue-supported RPDs, removable complete overdentures, fixed partial dentures (FPD), fixed complete dentures (FCD), bar and attachment supported dentures, Implant-retained long span bridges, All-on-4 or All-on-6 prostheses, Implant abutment and Implant-tissue supported partial dentures, implant supported full dentures, interim partials or interim full dentures, telescopic fixed partial dentures, cement- or metallic- or acrylic- or ceramic-, or friction- or bar-retained appliances.

Some dental prosthetics may generally be wider or thicker than others, and thus wider prosthetics may require a multiplicity of implant devices to be installed at a multiplicity of edentulous sites, wherein the multiplicity of implant devices may include two or more implant devices. In some embodiments, a multiplicity of implant devices may be inserted at a multiplicity of edentulous sites, so that locations of inserted implant devices may collectively form an approximate arrangement, wherein, the arrangement may include an approximate straight line, an approximate curved line, or a scattered dispersion or substructure (i.e. bar) inserted over multiple implants to support a prosthesis. FIG. 24A and FIG. 24B illustrate a flowchart 2400 of an exemplary method of fitting a denture to a patient, in accordance with an embodiment of the present invention, where FIG. 24A illustrates a start of the method, and FIG. 24B illustrates an end thereof. A first step of a present embodiment may begin with a step 2405, wherein a patient may be anesthetized. Next, in a step 2410, a dental bur, a ridge split chisel, or piezo dental device may be used to make a 2-50 mm mid-crestal slit on an edentulous site depending on the length and width chosen for the local site. In a step 2415, an exemplary, without limitation, implant device, in accordance with an embodiment of the present invention, may be placed in the slit. An X-ray may be taken for verification of an initial placement of the implant device. Afterwards, in a step 2420, an exemplary, without limitation, implant device carrier and an implant device inserter, in accordance with an embodiment of the present invention, may be used to insert the dental implant by driving the implant into an optimal orientation, position, and initial depth. The implant device may be further driven to a desired depth, wherein a current depth may be checked by observing visual height markings on the dental implant device. Next, in a step 2425, a stability of the inserted implant device may also be checked, wherein the checking may include gently wriggling the implant device carrier and possibly identifying movement of the implant device. The inserted implant device may not be stable, and thus the device carrier and the implant device inserter may again be used to drive the implant device to a deeper depth, in a step 2430. Thereafter, the stability may be checked again. If the implant device may be determined to be stable, and thus successfully installed, an additional determination of whether another implant device may be needed may be made in a step 2435. If another implant device may be needed, then another edentulous site may be selected in a step 2440, and the process may begin again at step 2410. If another implant device may not be needed, referring now to FIG. 22B, interim prosthetics, such as and without limitation, dental temporaries, interim dental appliances, or a supporting substructure(s) may be removably or fixedly inserted over installed implant devices, teeth, and edentulous sites and fixed with a temporary or permanent cement, in a step 2445. In case overall desirable stability is not reached in order to optimally install a final prosthesis, a 6-month waiting period may be allowed for acceptable osseointegration. The interim prosthetic may be configured to protect the installed implant devices, teeth, and edentulous sites, and also may distribute essentially full mouth forces, therefore generally allowing a patient to perform typical oral activities such as, without limitation, eating and talking during this time period. The interim prosthetics may be fixed during this healing time. However, permanent prosthesis may be a removable snap on or a permanently cemented prosthesis may be utilized depending on functional factors, patient's oral hygiene habits, as well as functional and esthetic considerations. Next, in a step 2450, a denture or partial denture may be fabricated and a prefabricated denture housing may be picked up by a denture relined procedure and processed in the denture, to optimally fit or snap into place, over the multiplicity implants with or without a supporting substructure depending on local anatomy, bite forces, location, opposing arch, and related functional considerations. The fabricated denture and denture housing may be joined to a multiplicity of installed implant devices and/or their joining substructure in a fixed cemented or removable snap on or friction grip manner in a step 2255 There may a multiplicity of conventional steps when creating a denture or an implant supported dentistry, which include impressions, baseplates and wax-rims, bite registration, teeth setting, and the final process of the denture. With the chairside technique of an already existing denture, housings are placed over support structures (i.e. bar or implant abutment portion and picked up permanently via denture acrylic material (time set or light cured). In the lab technique, a pick-up impression of the housing is made before the final processing of the denture allowing the housing to permanently be embedded in the denture before insertion. Furthermore, in the present embodiment, a denture or partial denture may also be joined to just one installed implant device. In some alternative embodiment the locations of the inserted implants may not include teeth in-between the locations. In some other alternative embodiments, the locations of the inserted implants may include at least one tooth in-between the locations. In yet some other alternative embodiments, the locations of the inserted implants may include more than one tooth in-between the locations. In other alternative embodiments, the denture may be simply fitted or cemented (with a temporary or permanent cement) to abutment portions of the implant devices, without housings.

In some alternative embodiments of the present invention a dental implant system may include an automated robotic computing device, wherein the automatic robotic computing device may include one or more processors, one or more data storage memories, one or more processing memories, a GUI, an imaging device and a multiplicity of actuating motors. Furthermore, the one or more data storage memories may comprise executable computer-readable instructions that when executed may cause the automated robotic to capture X-ray computed tomography (X-ray CT) and computerized axial tomography scan (CAT scan) image data of an implant insertion site. In some alternative embodiments, an automated robotic computing device may further execute computer-readable instructions to process that captured image data to perform a radiographic study and potentially determining quality of bone at the implant insertion site. In some other alternative embodiments, the automated robotic computing device may include one or more projection devices, wherein executing computer-readable instructions may cause the automated computing robotic device to process the image data, actuate the projection devices, and intraorally project an implant site map. An implant site map may be visualized over a multiplicity of intraoral areas where implant devices may be inserted. In some other alternative embodiments, the automated computing robotic device may process the image data to and execute a fabrication process, wherein a particular polygonal, dental implant device, in accordance with an embodiment of the present invention, may be fabricated. In another alternative embodiment the automated robotic computing device may execute computer readable instructions to intraorally place a dental implant device in accordance with an embodiment of the present invention.

Those skilled in the relevant art would readily recognize, in light of and in accordance with the teachings of the present invention, that many of the foregoing features of the embodiments of an implant device and implant device system or combination thereof, may be utilized in the exemplary method steps described above depending upon the needs of a particular application.

Those skilled in the relevant art would further readily recognize, in light of and in accordance with the teachings of the present invention, that any of the foregoing features of the embodiments, may be suitably combined, substituted, removed, added to, and altered depending upon the needs of a particular application.

Those skilled in the art will readily recognize, in light of and in accordance with the teachings of the present invention, that any of the foregoing steps and/or system components may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system, an or robotics and automation machine of placement, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing an implant device according to the present invention will be apparent to those skilled in the art. Various aspects of the invention have been described above by way of illustration, and the specific embodiments disclosed are not intended to limit the invention to the particular forms disclosed. The particular implementation of the implant device may vary depending upon the particular context or application. By way of example, and not limitation, the implant device described in the foregoing were principally directed to single unit, serrated or smooth edge sides, polygon shaped in cross section and or circumference, dental implant device implementations; however, similar techniques may instead be applied to screws for bone fixations and fractures, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A device comprising:
an implant device, in which said implant device is configured to join to a bone without screws or attachable abutments;
a body portion having a cornered shape, wherein said cornered shape comprising at least one corner configured to prevent a rotational movement of said implant device;
a wedging edge portion having a wedge shape, wherein said wedge shape is a proximate tapered beveled shape that is configured to allow said implant device to wedge into the bone;
an apical end portion comprising a proximate bottom end section and a beveled side, wherein said beveled side is configured to form a proximate chisel shape;
a hole structure, in which said hole structure comprises at least two or more holes, wherein said hole structure is configured to be operable for osseointegration with the bone;
a joining surface, in which said joining surface comprises at least a two or more serrations to form at least a proximate saw-like or jagged shape joining surface along said bottom end section;
and
a height marking, in which said height marking comprises at least two or more visible height markings along said body portion, wherein said height marking is configured to be operable as a basis and visual aid with respect to a depth at which said implant device is inserted into the bone.

2. The device of claim 1, in which said implant device comprises at least a biocompatible material.

3. The device of claim 1, in which said implant device is comprised of at least a zirconia.

4. The device of claim 3, in which said bottom end section of said apical end portion is configured to be operable for allowing said implant device to have a strong engagement to said bone.

5. The device of claim 1, in which said implant device comprises at least a titanium alloy.

6. The device of claim 5, in which said bottom end section of said apical end portion comprises at least a beveled segment.

7. The device of claim 6, in which said bottom end section of said apical end portion is configured to allow said implant device to have a strong engagement to said bone, by a growth of said bone around said saw-like or jagged shape joining surface along said bottom end section.

8. The device of claim 7, wherein said hole structure is further configured to provide a firm anchoring of said implant device to said bone, by a growth of said bone around said hole structure.

9. The device of claim 2, in which said apical end portion comprises, at least a bevel, wherein said apical end portion is configured to gradually increase in dimension coronally, and wherein said apical portion is further configured to expand a ridge when inserted and installed into position.

10. The device of claim 9, in which said hole structure further comprises at least a stem cell, wherein said stem cell is configured to aid in, at least one of, a bone growth process, a bone healing process and a bone restoration process.

11. The device of claim 2, in which said body portion is a solid having a minimum thickness of at least proximately 2 mm and a maximum thickness of at least proximately 20 mm.

12. The device of claim 11, in which said a cornered shape comprises at least a polygon shape, wherein said polygon shape is configured as a closed loop bounded by a finite chain of line segments including at least one of, a triangular shape, a square shape, a rectangular shape, an octagonal shape, a trapezoidal shape, a hexagonal shape, a rhomboidal shape, and a quadrilateral shape, and wherein said implant device cornered shape is configured to provide a locking retention when joined to some prosthetics.

13. The device of claim 11, in which said cornered shape comprises a polygon shape, in which said polygon shape including at least one of an equilateral polygon, a simple polygon, a complex polygon, a concave polygon, a convex polygon, and an irregular star shape polygon, and wherein said polygon shaped implant device is configured to provide a locking retention when joined to some prosthetics.

14. The device of claim 1, in which said cornered shape comprises at least a multiplicity of corners configured to create at least a rotational or circumferential lock.

15. The device of claim 1, in which said implant device comprises a gradual taper from a top portion of said implant device to said bottom end section, wherein said implant device is thicker or wider at said top portion than at said bottom end section to generally aid in a ridge expansion.

16. A device comprising:
an implant device, in which said implant device is configured to join to a bone without screws or attachable abutments;
a body portion having a cornered shape, wherein said cornered shape comprising at least one corner configured to prevent a rotational movement of said implant device;
a wedging edge portion having a wedge shape, wherein said wedge shape is proximately a tapered beveled shape that is configured to allow said implant device to wedge into a surrounding bone;
an apical end portion comprising a bottom section and a beveled side, wherein said beveled side is configured to form a generally chisel like-shape;
a joining surface, in which said joining surface comprises at least one or more serrations to form at least a proximate saw-like or jagged shape joining surface along said bottom section; and
a visual height marking, in which said visual height marking comprises at least two or more visible height markings along said body portion, and wherein said visual height marking is configured to be operable as a basis and visual aid with respect to a depth at which said implant device is inserted into the bone.

17. The device of claim 16, in which said bottom section of said apical end portion comprises at least one of, a serrated and jagged surface, wherein said serrated or jagged surface is configured to allow said implant device to have a strong engagement to said bone.

18. The device of claim 16, in which said apical end portion further comprising at least a hole structure being configured to be operable for an osseointegration process, wherein said hole structure is configured to provide a firm anchoring of said implant device to said bone, by a growth of said bone around said hole structure.

19. The device of claim 17, in which said cornered shape comprises at least a polygon shape, wherein said polygon shape is configured as a closed loop bounded by a finite chain of line segments including at least one of, a triangular shape, a square shape, a rectangular shape, an octagonal shape, a trapezoidal shape, a hexagonal shape, a rhomboidal shape, and a quadrilateral shape, an equilateral polygon, a simple polygon, a complex polygon, a concave polygon, a convex polygon, and an irregular star shape polygon, and wherein said polygon shaped is configured to provide a locking retention when joined to a prosthetic.

20. A device consisting essentially of:
an implant device, in which said implant device is configured to join to a bone;
means for joining said implant device to a bone without screws or attachable abutments;
means for preventing a rotational movement of said implant device;
means for allowing said implant device to wedge into said bone;
means for providing said implant device a strong engagement to the bone;
means for allowing a bottom end section of said implant device to have a strong engagement to the bone, wherein said bottom end section comprises at least a saw-like or jagged shape joining surface;
means for providing a basis and visual aid with respect to a depth at which said implant device is inserted into the bone; and
means for anchoring of said implant device to said bone, by a growth of said bone around said anchoring means.
